(19) United States
(12) Patent Application Publication
(10) Pub. No.: US 2018/0368393 A1
(43) Pub. Date: Dec. 27, 2018

(54) PRE- AND POST-STORAGE STRESS RESPONSE CONDITIONING

(71) Applicant: CPSI HOLDINGS LLC, Owego, NY (US)

(72) Inventors: John M. Baust, Candor, NY (US); Kristi K. Snyder, Candor, NY (US); Robert G. VanBuskirk, Apalachin, NY (US)

(21) Appl. No.: 16/019,072

(22) Filed: Jun. 26, 2018

Related U.S. Application Data
(60) Provisional application No. 62/524,664, filed on Jun. 26, 2017.

(51) Int. Cl. A01N 1/02

(52) U.S. Cl. CPC A01N 1/0226

(57) ABSTRACT

Disclosed herein are conditioning media, supplements for addition to culture or other type of media, and methods for conditioning biological samples before, after, or both before and after preservation for improved recovery outcomes, e.g., cell survival and repopulation. Also disclosed herein are cryoprotective agents and solutions or media containing cryoprotective agents for preservation of biological samples with improved recovery outcomes.

### CROSS REFERENCE TO RELATED APPLICATION

This patent application claims the benefit under 35 U.S.C. § 119(e) of U.S. Provisional Patent Application Ser. No. 62/524,664, filed Jun. 26, 2017, which is incorporated by reference as though fully set forth herein.

### GOVERNMENT LICENSE RIGHTS

This invention was made with government support under grant number 1R43HL130805-01A1 awarded by the National Institutes of Health (NIH). The government has certain rights in the invention.

### BACKGROUND

Cryopreservation is necessary to retain viability and functionality of biologics for extended periods of time, and to subsequently delivery cellular products for “on-demand” use. Numerous therapies and clinical trials utilize cells that have been cryopreserved. While cryopreservation (CP) is ubiquitous in many research and therapeutic areas, it remains a suboptimal process. For instance, sensitive cell systems (e.g. stem cells) have cell loss rates of >50% despite being cryopreserved in optimal dimethyl sulfoxide (DMSO) concentrations (10%).

Cryopreservation protocols known in the art include freezing samples at a controlled rate (slow cooling), allowing for osmotic flux and minimizing intracellular ice formation. Typical devices include controlled rate coolers, alcohol containers, and two-step cooling devices. Samples are typically stored in a dewar of liquid nitrogen (LN2), either liquid or vapor phase, or mechanical freezers. Thawing is typically accomplished through rapid rewarming of samples, e.g. in 37° C. water baths and dry thawers, with a goal of minimizing recrystallization of ice.

A number of challenges are associated with standard cryopreservation protocols, including low and variable yields, compromised quality of cell function, tedious multi-step processes, lack of definition in preservation media, inclusion of DMSO and animal-derived components (serum or glycerol), contamination and sterility concerns, difficulties with process definition, repeatability, uniformity, and bulky processing and storage protocols that are not user-friendly or scalable, and disconnect between assessed outcome and clinical observations. In view of these challenges, improvements in the cryopreservation process are desired in order to reduce the cost of cryopreserved samples for both clinical and research use.

In an effort to improve outcomes, the use of various cryoprotective agents (CPAs) has been investigated, including glycerol, ethylene glycol, propylene glycol, glucose, sucrose, trehalose, hydroxyethylstarch, dextran sulfate, methylcellulose, and polyvinylpyrollidone. While these alternative CPAs have virtues, none have proven to be as effective as DMSO. Given the toxicity and poor survival associated with DMSO-based approaches, new CP protocols are needed.

In addition to new protocols for samples to be cryopreserved, there is also a need for improvement in recovery outcomes associated with already-banked samples. Such samples represent a diversity of sample types, cell densities, cryopreservation media, cell protective additive types and concentrations, cooling rates, and thermal histories (including, e.g., time, temperature, cycling), further complicating efforts.

### BRIEF DESCRIPTION OF THE INVENTION

A first aspect of the disclosure provides a conditioning medium comprising: a medium selected from the group consisting of: a growth medium, a culture medium, a salt solution, an extracellular-like solution, an intracellular-like solution, or a preservation medium, and a first reagent that is a cell molecular pathway modulator.

A second aspect of the disclosure provides a supplement for addition to a medium, for use in preparing the conditioning medium according to the first aspect, the supplement comprising a first reagent capable of modulating a molecular pathway in a cell.

A third aspect of the disclosure provides a method comprising: in a medium, warming a biological sample that was previously cryopreserved or stored under hypothermic conditions; and after warming the biological sample in the medium, adding an effective amount of a post-thawing conditioning composition to the medium containing the biological sample to create a conditioned medium, wherein the conditioning composition comprises a first reagent that is a cell molecular pathway modulator, and wherein a concentration of the first reagent in the conditioned medium is 1% to 100% of a concentration of the reagent in the conditioning composition.

A fourth aspect of the disclosure provides a method comprising: adding a pre-conditioning reagent to a first medium in which the biological sample is contained, incubating the biological sample in the pre-conditioning reagent and the medium for about 1 hour; removing the medium containing the pre-conditioning reagent; adding a second medium to the biological sample; cryopreserving the biological sample or placing the biological sample in hypothermic storage in the second medium; warming a biological sample in the second medium; and after warming the biological sample in the medium, adding an effective amount of a post-warming conditioning reagent to the biological sample, wherein the post-warming-conditioning reagent is in the form of a conditioning medium or a supplement.

A fifth aspect of the disclosure provides a method comprising: adding a pre-conditioning reagent to a first medium in which the biological sample is contained, incubating the biological sample in the pre-conditioning reagent and the medium for about 1 hour; removing the medium containing the pre-conditioning reagent; adding a second medium to the biological sample; and cryopreserving the biological sample or placing the biological sample in hypothermic storage in the second medium.

A sixth aspect of the disclosure provides a method of conditioning a biological sample comprising: adding an effective amount of a conditioning medium or a conditioning supplement to a medium containing the biological sample, such that a concentration of a reagent in the composition is 1% to 100% of a concentration of the reagent in the composition, wherein the reagent is present in the composition in a concentration of about 1 nM to about 500 nM, or about 100 nM to about 20 mM, or about 1 nM to about 5 M, the composition is in the form of a tablet, a liquid, or a powder, and the reagent is an apoptotic inhibitor, an oxidative stress modulator, a free radical scavenger, or an Unfolded Protein Response modulator.

A seventh aspect of the disclosure provides a cryoprotective agent supplement for use in for the cryopreservation of cells, the supplement comprising: a first reagent capable of protecting biologics from ice damage during the freezing and thawing process.

An eighth aspect of the disclosure provides a method preserving a biological sample comprising: pre-conditioning the biological sample with a reagent; and cryopreserving the biological sample.

A ninth aspect of the disclosure provides a method of recovering a cryopreserved biological sample comprising: thawing a cryopreserved biological sample; and after thawing the biological sample, conditioning the biological sample with a reagent.

A tenth aspect of the disclosure provides a method of recovering a cryopreserved biological sample comprising: thawing a cryopreserved biological sample; and after thawing the biological sample, diluting the sample directly with the conditioning media or media supplemented with the conditioning supplement reagent

An eleventh aspect of the disclosure provides a method comprising: pre-conditioning the biological sample with a first reagent; cryopreserving the biological sample; thawing the cryopreserved biological sample; and after thawing, conditioning the biological sample with a second reagent.

A twelfth aspect of the disclosure provides a method comprising: adding a cryoprotective agent supplement to a preservation media; cryopreserving the biological sample; and thawing the cryopreserved biological sample.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 illustrates the results of an assessment of human endothelial cell survival following cryopreservation.

FIG. 2 illustrates the results of an assessment of the Unisol-based solutions with and without reduced CPA on human endothelial survival following cryopreservation.

FIG. 3 illustrates the results of an assessment of the impact of apoptotic inhibition pre-freeze conditioning on human endothelial cell survival on day 1 following cryopreservation with and without reduced CPA.

FIG. 4 illustrates the results of an assessment of the impact of apoptotic inhibition pre-freeze conditioning on human endothelial cell repopulation three (3) days following cryopreservation with and without reduced CPA.

FIG. 5 illustrates the results of an assessment of the impact of apoptotic inhibition post-freeze conditioning on human endothelial cell survival 1 day following cryopreservation with and without reduced CPA.

FIG. 6 illustrates the results of an assessment of the impact of apoptotic inhibition post-freeze conditioning on human endothelial cell repopulation 3 days following cryopreservation with and without reduced CPA.

FIG. 7 illustrates the results of an assessment of apoptotic inhibition pre- and post-freeze conditioning on human endothelial cell survival 1 day following cryopreservation with and without reduced CPA.

FIG. 8 illustrates the results of an assessment of the impact of apoptotic inhibition pre- and post-freeze conditioning on human endothelial cell repopulation 3 days following cryopreservation with and without reduced CPA.

FIG. 9 illustrates the results of an assessment of the impact of oxidative stress modulators pre- and post-freeze conditioning on human endothelial cell survival 1 day following cryopreservation with and without reduced CPA.

FIG. 10 illustrates the results of an assessment of the impact of oxidative stress modulators pre- and post-freeze conditioning on human endothelial cell repopulation 3 days following cryopreservation with and without reduced CPA.

FIG. 11 illustrates the results of an assessment of the impact of oxidative stress modulators pre-freeze conditioning on human endothelial cell survival 1 day following cryopreservation with and without reduced CPA.

FIG. 12 illustrates the results of an assessment of the impact of oxidative stress modulators pre-freeze conditioning on human endothelial cell repopulation 3 days following cryopreservation with and without reduced CPA.

FIG. 13 illustrates the results of an assessment of the impact of oxidative stress modulators post-thaw conditioning on human endothelial cell survival 1 day following cryopreservation with and without reduced CPA.

FIG. 14 illustrates the results of an assessment of the impact of oxidative stress modulators post-thaw conditioning on human endothelial cell repopulation 3 days following cryopreservation with and without reduced CPA.

FIG. 15 illustrates the results of an assessment of human smooth muscle cell survival following cryopreservation in Unisol-based solutions with and without reduced CPA.

FIG. 16 illustrates the results of an assessment of the impact of apoptotic inhibition pre-freeze conditioning on human smooth muscle cell survival 1 day following cryopreservation with and without reduced CPA.

FIG. 17 illustrates the results of an assessment of the impact of apoptotic inhibition pre-freeze conditioning on human smooth muscle cell repopulation 3 days following cryopreservation with and without reduced CPA.

FIG. 18 illustrates the results of an assessment of the impact of apoptotic inhibition post-freeze conditioning on human smooth muscle cell survival 1 day following cryopreservation with and without reduced CPA.

FIG. 19 illustrates the results of an assessment of the impact of apoptotic inhibition post-freeze conditioning on human smooth muscle cell repopulation 3 days following cryopreservation with and without reduced CPA.

FIG. 20 illustrates the results of an assessment of the impact of apoptotic inhibition pre- and post-freeze conditioning on human smooth muscle cell survival 1 day following cryopreservation with and without reduced CPA.

FIG. 21 illustrates the results of an assessment of the impact of apoptotic inhibition pre- and post-freeze conditioning on human smooth muscle cell repopulation 3 days following cryopreservation with and without reduced CPA.

FIG. 22 illustrates the results of an assessment of the impact of oxidative stress modulators pre- and post-freeze conditioning on human smooth muscle cell survival 1 day following cryopreservation with and without reduced CPA.

FIG. 23 illustrates the results of an assessment of the impact of oxidative stress modulators pre- and post-freeze conditioning on human smooth muscle cell repopulation 3 days following cryopreservation with and without reduced CPA.

FIG. 24 illustrates the results of an assessment of the impact of oxidative stress modulators pre-free conditioning on human smooth muscle cell survival 1 day following cryopreservation with and without reduced CPA.

FIG. 25 illustrates the results of an assessment of the impact of oxidative stress modulators pre-freeze conditioning on human smooth muscle cell repopulation 3 days following cryopreservation with and without reduced CPA.

FIG. 26 illustrates the results of an assessment of the impact of oxidative stress modulators pre-thaw conditioning on human smooth muscle cell survival 1 day following cryopreservation with and without reduced CPA.

FIG. 27 illustrates the results of an assessment of the impact of oxidative stress modulators post-thaw conditioning on human smooth music cell repopulation 3 days following cryopreservation with and without reduced CPA.

FIG. 28 illustrates the results of an assessment of the impact of post-thaw oxidative stress and apoptotic conditioning on human hematopoietic stem cell survival following cryopreservation and water bath thawing.

FIG. 29 illustrates the results of an assessment of the impact of post-thaw oxidative stress and apoptotic conditioning on human hematopoietic stem cell survival following cryopreservation and thawing using a thawing device.

FIG. 30 illustrates the results of an assessment of the impact of post-thaw molecular modulation on liver cell survival following cryopreservation.

FIG. 31 illustrates the results of an assessment of the impact of post-thaw molecular modulation on kidney cell survival following cryopreservation.

FIG. 32 illustrates the results of an assessment of the impact of post-thaw molecular modulation on prostate cell survival following cryopreservation.

FIG. 33 illustrates the results of an assessment of the impact of post-thaw molecular modulation on beta islet cell survival following cryopreservation.

FIG. 34 illustrates the results of an assessment of the impact of post-thaw molecular modulation on beta islet cell survival following hypothermic storage.

FIG. 35 illustrates the results of an assessment of the impact of post-thaw molecular oxidative stress modulation on fibroblast cell survival following hypothermic storage.

FIG. 36 illustrates the results of an assessment of the impact of post-thaw molecular apoptotic modulation on fibroblast cell survival following hypothermic storage.

The drawings are intended to depict only typical aspects of the disclosure, and therefore should not be considered as limiting the scope of the disclosure.

### DETAILED DESCRIPTION OF THE INVENTION

Embodiments of the present invention are described below in reference to their application in connection with conditioning media and/or supplements for addition to cryopreservation and culture media, methods for preserving biological samples, and methods for recovering biological samples which have been preserved according to methods disclosed herein or any method as known in the art. At least one embodiment of the present invention is described below in reference to a nominal set of specifications, e.g., concentration by volume. However, it should be apparent to those skilled in the art that the present invention is likewise applicable to other specifications which provide similar attributes.

Unless otherwise indicated, the abbreviations and expressions used in the present disclosure have the following meanings:

AI apoptotic inhibitor

CP cryopreservation

CPA cryoprotective agent

CP sol cryopreservation solution

CVI caspase inhibitor

D10 Media+10% DMSO

DMSO dimethyl sulfoxide

DP6 commercially available cryopreservation solution produced by Tissue Testing Technologies, LLC (“T3”)

EC Eurocollins

G10 Glycerol+10% DMSO

Gly Glycerol

Ham's F12 commercially available culture media formula

HBSS Hank's Balanced Salt Solution

hHSC Human hematopoietic stem cells

HEC Human endothelial cell

JNK Jun kinase inhibitor

M5 Media+5% DMSO

M10 Media+10% DMSO

M22 commercially available cryopreservation solution produced by 21^{st} Century Medicine (“21CM”)

NAC n-acetyl cysteine

OSI oxidative stress inhibitor

PF pre-freeze conditioning

PW post-warming (or post-thawing) conditioning

P/P pre-/post-warming conditioning (or pre-/post-thawing) conditioning

ROSI reactive oxygen species inhibitor, free radical scavenger

RPMI commercially available culture media formula (Roswell Park Memorial Institute)

SCGM commercially available culture media formula (stromal cell growth media)

Uni UNISOL intracellular like solution, a specialty preservation medium (Lifeline Scientific, Inc.)

U5 Uni+5% DMSO

U10 Uni+10% DMSO

U20 Uni+20% DMSO

UG10 Uni+10% Glycerol

U5G10 Uni+5% DMSO+10% Glycerol

U10G10 Uni+10% DMSO+10% Glycerol

UPRI unfolded protein response inhibitor

Vitrification a form (sub-category) of cryopreservation in which formation of ice crystals is avoided

VS55 commercially available cryopreservation solution produced by Tissue Testing Technologies, LLC (“T3”)

VS83 commercially available cryopreservation solution produced by Tissue Testing Technologies, LLC (“T3”)

### Example 1: Cryopreservation Solutions

A series of cryopreservation experiments was conducted on human endothelial and smooth muscle cell suspensions and monolayers to assess the performance of four (4) commercially available cryopreservation solutions: DP6, VS55, VS83, and M22, as well as nine (9) additional solutions: Eurocollins (EC), Unisol (Uni), Uni+5% DMSO (U5), Uni+10% DMSO (U10), Uni+20% DMSO (U20), Uni+10% Glycerol (UG10), Uni+5% DMSO and 10% Gly (U5G10), Uni+10% DMSO and 10% Gly (U10G10), and media+10% DMSO (D10). Eurocollins (EC) solution was included as a negative control, i.e., no cryoprotective agent (CPA) control, while media+10% DMSO (D10) is a typical solution (10% DMSO) used in standard controlled rate cryopreservation protocols known to the skilled individual. Unisol is representative of the class of intracellular-like or intracellular-type solutions/media, whereas EC solution and culture media are representative of the class of extracellular-like or extracellular-type solutions/media. Other studies presented herein provide additional examples of intracellular- and extracellular-like solutions; other intracellular- and extracellular-like solutions are similarly useful and are known to those of skill in the art.

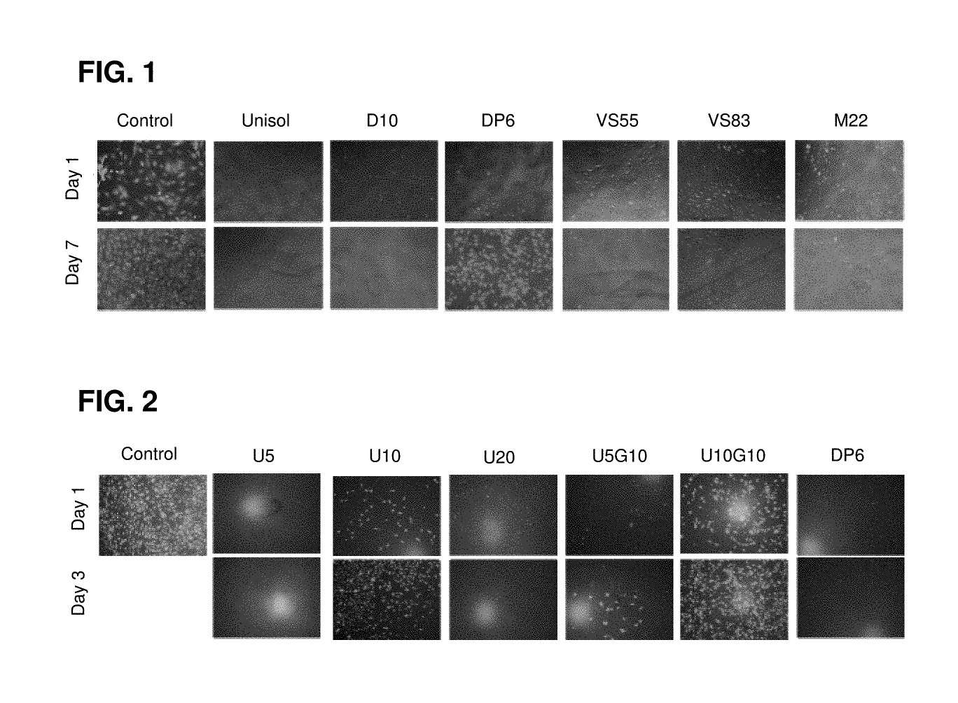

FIG. 1 illustrates the results of an assessment of human endothelial cell survival following preservation. Monolayers of endothelial cells were frozen or vitrified and thawed in the indicated solutions (control, Uni, D10, DP6, VS55, VS83, and M22). Following thawing, samples were diluted in culture media, placed into culture and assessed for viability at 1 day (24 hours) post-thaw and following seven (7) days of recovery using the Calcein-AM assay. Fluorescent images indicate that DP6 provided the highest level of survival and repopulation of the commercially available solutions (compared to control, Unisol, D10, VS55, VS83, and M22). The Uni and U10 conditions provided outcomes exceeding that of the VS55, VS83 and M22 conditions. Therefore, subsequent studies (see, e.g., FIG. 2) focused on Unisol-based solutions with various CPAs and concentrations, in addition to the DP6 commercial cryopreservation solution.

FIG. 2 illustrates the results of an assessment of five Unisol-based solutions (U5, U10, U20, U5G10, and U10G10) with and without reduced CPA on human endothelial survival following preservation. For purposes of this disclosure, “with reduced CPA” refers to solutions having less than about 20% CPA, while “without reduced CPA” refers to solutions having greater than or equal to about 20% CPA, i.e., CPA concentrations that are not reduced. Monolayers of endothelial cells were frozen or vitrified and thawed in the indicated solutions. Following thawing, samples were diluted in culture media, placed into culture, and assessed for viability at day 1 (24 hours) post-thaw, and again following 3 days of recovery using the Calcein-AM assay. Analysis indicates that the Unisol+CPA solutions provided improved survival and repopulation compared to the commercially available vitrification solution, DP6. Most notably, the U10G10 condition yielded ˜50% survival and repopulated to a monolayer exceeding pre-free controls within 3 days.

### Conditioning Studies: Examples 2-11

A series of preservation (cryopreservation, vitrification, and hypothermic storage) experiments was conducted on cell types including endothelial, smooth muscle, liver, kidney, prostate, beta islet, fibroblast, and stem cells to assess the impact of pre-freeze (PF), post-warming (PW) and pre/post (P/P) conditioning using a variety of molecular modulators on post-preservation survival of the cell populations.

For pre-freeze (PF), post-warming (PW) and pre/post (P/P) conditioning studies, molecular modulation agents targeting inhibition of apoptosis (Caspase inhibitor IV, 8, 9 and a combination of Caspases 8 and 9), reduction of free-radical damage (resveratrol and NAC), and activation of the unfolded protein response (salubrinal) were employed as supplements in the media 1 hour prior to freezing (pre-freeze condition) or for 1 day following thawing and CPA removal from frozen samples (post-warming condition). Based on outcomes in the studies in Example 1, PF, PW and P/P conditioning were examined in Examples 2-3 using a series of Unisol-based solutions (Uni, U5, U10, U20, UG10, U5G10 and U10G10).

Studies of Examples 2-3 were conducted using human endothelial and smooth muscle cells as the cell models. These cells are critical components of blood vessels which make up the vascular network of any tissue or organ system. Preservation of these cell types is key to the preservation of any tissue or organ. As such, successful preservation of these cells is a key step and indicator in successful tissue and organ preservation. The evaluation of PF, PW, and P/P conditioning of samples in monolayer culture models the lining of vasculature in tissues.

Samples in Examples 2-3 were frozen using a rapid cooling protocol of direct placement from 4° C. into LN₂ vapor (approximately −190° C.) for freezing and rapid warming of the monolayers in plates using the thawing device described in U.S. Patent Application Publication No. US 2016/0097583 A1 (Ser. No. 14/876,087), which is incorporated by reference in its entirety as though fully set forth herein. The freeze and thaw process was slightly modified relative to the disclosure of U.S. Patent Application Publication No. US 2016/0097583 A1 by the addition of a 0.090 inch aluminum plate inserted into the bottom of the 96 well plate to aid in increasing cooling and heating uniformity throughout the plate, thereby reducing the well-to-well variability within the samples. The device was used to thaw the samples, which were frozen in situ in monolayers in standard 96-well tissue culture plates. Samples were thawed from less than −170° C. to about 4° C. in the 96-well plate format in about 5 mins in a dry clean (“sterile”) environment.

### Example 2: Human Endothelial Cells

### Example 2.1

With the establishment in Example 1 of less than 20% 24 hour endothelial cell survival following cryopreservation in the seven standard cryopreservation solutions and the marked improvement in survival in the Unisol+CPA conditions, analysis of the impact of caspase inhibition prior to freezing (PF) and during post-thaw (post-warming, or PW) recovery was conducted. A mitochondrial-mediated apoptotic inhibitor (Caspase 9) and a membrane-mediated apoptotic inhibitor (Caspase 8) were investigated to evaluate the involvement and impact of modulation of various apoptotic induction pathways. Additionally, a pan-Caspase inhibitor (Cas IV) was also investigated to assess the impact of global pathway modulation. As with the viability studies, cell survival and repopulation were assessed using Calcein-AM assays and analyzed using fluorescent microscopy (Zeiss). Survival was determined at 24 hours post-thaw to allow for the manifestation of any delayed onset cell death pathways to be executed. Further, cell recovery was included to evaluate the long term potency and repopulation potential of the various samples.

For pre-freeze (PF) conditioning studies, 1 hour prior to CP addition, culture media was decanted and 100 μL of fresh media supplement with Caspase 8, 9, or IV was added to each respective well. Samples were then incubated at 37° C. for 1 hour, followed by media removal, and addition of 100 μL of EC or sample CP solution using a single step or serial addition protocol and then frozen. Following storage, samples were thawed and diluted using a single step or serial dilution protocol and placed into culture for 24 hours. The serial addition and dilution process consisted of a multistep increase of decrease in the concentration of the CPA within the sample to reduce osmotic stress and shock on a sample. Following thawing and 24 hours recovery, cell viability was assessed.

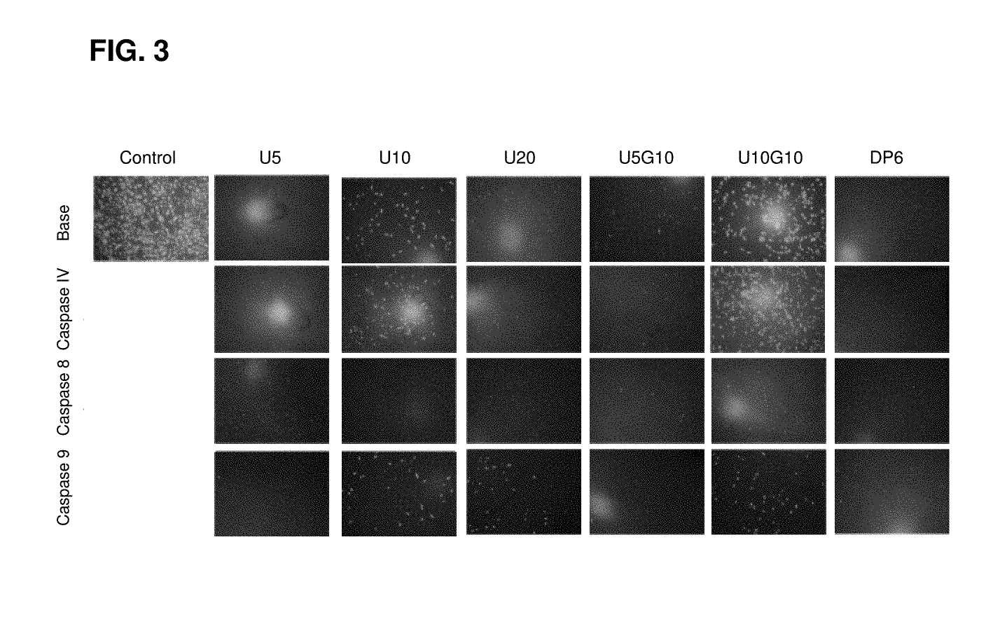

FIG. 3 illustrates the impact of apoptotic inhibition pre-freeze (PF) conditioning on human endothelial cell survival on day 1 following cryopreservation with and without reduced CPA. The images indicate an initial improvement in survival in the Unisol+CPA conditions when pretreated with Caspase IV (broad based apoptotic inhibitor). Pre-treatment with Caspase 9 inhibitor (mitochondrial-based apoptosis) alone yielded no protective benefit. Notably, in the U10G10 sample, Caspase IV inhibitor pretreatment resulted in a marked improvement in Day 1 survival compared to non-treated samples yielding ˜70% survival when compared to controls. However, these studies revealed minimal improvement in overall cell survival with PF conditioning compared to non-conditioned samples. However, the U10G10 Caspase IV condition provided increased cell survival, with an increase from about 50% to about 60% compared to controls.

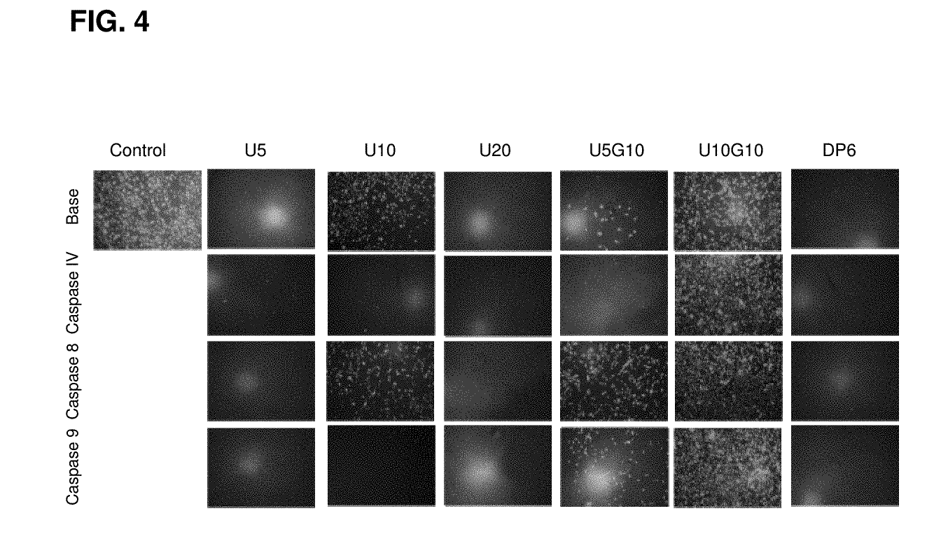

With reference to FIG. 4, analysis of the sample (of FIG. 3) recovery at 3 days post-thaw revealed an improvement in recovery in the Unisol+CPA conditions when pretreated with Caspase IV and 8. Pretreatment with Caspase 9 inhibitor (mitochondrial based apoptosis)-only yielded no protective benefit. Notably, Caspase IV inhibitor pretreatment resulted in a marked improvement in recovery in the U10 and U5G10 samples compared to non-treated samples. U10G10 samples recovered to a monolayer beyond that of controls in all conditions by day 3.

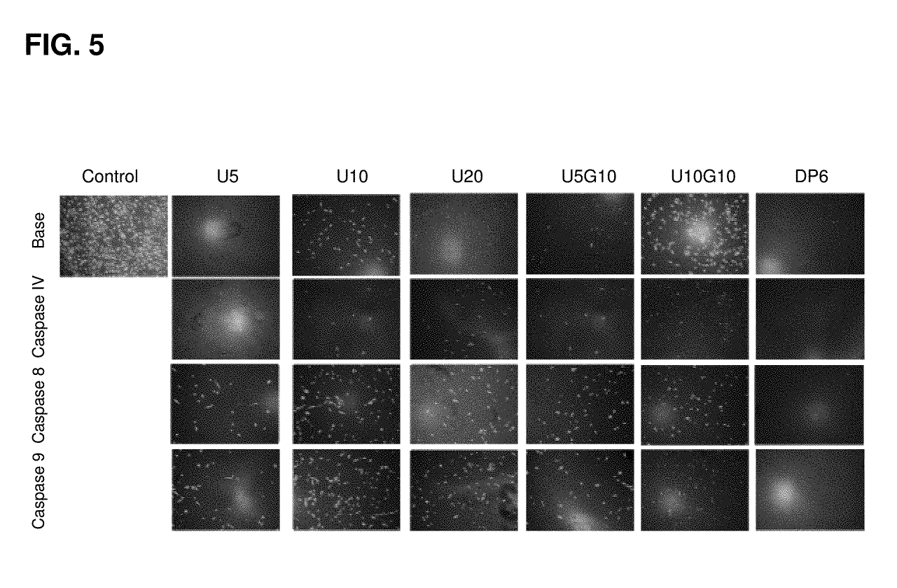

For post-warming (PW) conditioning studies, following thawing and CP solution removal, 100 μL of culture media supplemented with Caspase 8, 9, or IV was added to each sample. FIG. 5 illustrates the impact of apoptotic inhibition post-freeze conditioning on human endothelial cell survival 1 day following preservation with and without reduced CPA. Monolayers of endothelial cells were frozen or vitrified and thawed in the indicated solutions. Following thawing, samples were placed into culture for 24 hours with the indicated inhibitors and then assessed for viability using the Calcein-AM assay. Fluorescent images indicate a slight improvement in cell survival in Caspase 8 and 9 samples compared to their non-treated matched samples. Images again indicate an initial improvement in survival in the Unisol+CPA conditions but revealed no substantial benefit for post-treatment with caspase inhibitors following 1 day recovery with and without reduced CPA concentrations beyond that achieved with the U10G10 condition.

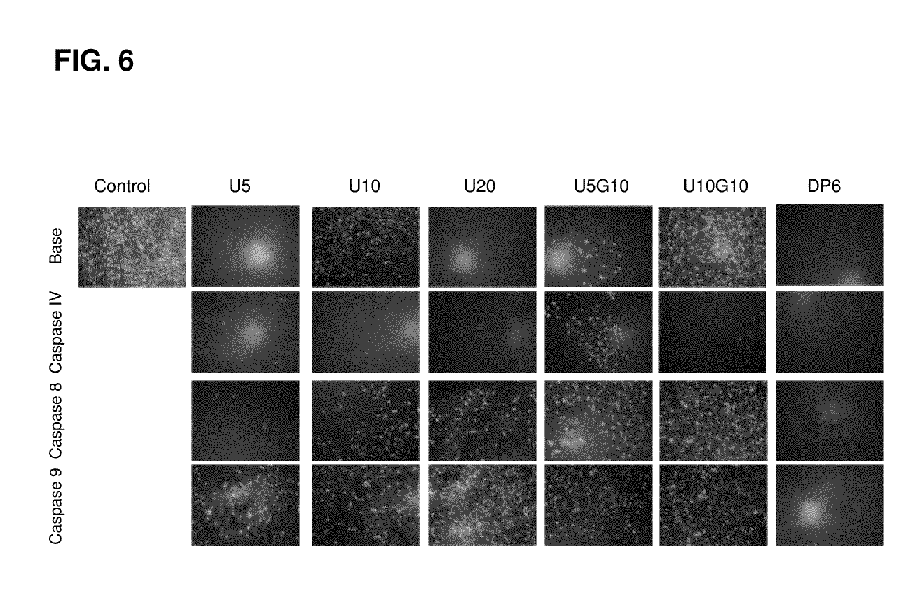

The PW conditioning of the Unisol+CPA solutions with the Caspase 8 inhibitor resulted in an overall increase in cell survival over both the non-conditioned and PF conditioned samples (see, U5, U10, U5G10 and U10G10 in FIG. 3). FIG. 6 illustrates the impact of apoptotic inhibition post-freeze conditioning on human endothelial cell repopulation 3 days following preservation with and without reduced CPA. Monolayers of epithelial cells were frozen or vitrified and thawed in the indicated solutions. Following thawing, samples were diluted and placed into culture for 24 hours in media supplemented with the indicated inhibitor (Caspase 8, 9, and IV) and then the inhibitor was removed and samples were assessed for viability at 3 days post-thaw using the Calcein-AM assay. An improvement in cell recovery was observed in the Unisol+CPA conditions following post-treatment conditioning with Caspase inhibitor 8 and 9. Notably, Caspase 8 and 9 inhibition post-treatment improved recovery in reduced CPA conditions. However these were below the U10G10 condition with or without inhibitors. Caspase 8 and 9 inhibition resulted in a marked improvement in day 3 recovery in the U10, U20, and U5G10 compared to non-treated samples. U10G10 samples recovered to a monolayer beyond that of controls and other experimental conditions by day 3. Thus, the observed increase in survival in the U10, U5G10 and U10G10 Caspase 8 and 9 samples translated to increased cell repopulation over a three day recovery period, yielding a cell monolayer in several of the conditions. This represents a marked improvement over the best recovery achieved with DP6 with post-thaw conditioning using caspase inhibition where, after a 7 day recovery, less than 90% recovery was observed (FIG. 3). Assessment of Caspase 9 conditioned samples also revealed improvement over that of non-conditioned controls. The improvement in endothelial cell recovery using post-thaw conditioning (PW) in Caspase inhibitors supported prior findings that while necrosis dominated, there was an underlying apoptotic mechanism driving the death response (initial cell death analysis performed using the YO-PRO apoptosis/necrosis assay using GUAVA (Millipore Corp) microfluidic flow cytometry and fluorescent microscopy). In this case, the addition of apoptotic inhibitors resulted in the improvement of cell survival and recovery.

Overall, the caspase inhibitor pre-freeze (PF) and post-thaw (PW) conditioning molecular modulation analysis in Example 2.1 revealed that the use of caspase inhibition (specifically Caspase 8 inhibitor) resulted in an improvement in cell recovery and repopulation following cryopreservation in the U10G10 solution as well as yielded an improvement in cell number post-thaw in several of the solutions, CPAs, CPA combinations, and CPA concentrations, as well as freeze and thaw protocols evaluated (U5, U10 and U5G10).

### Example 2.2

With the establishment of benefit of pre- and post-conditioning strategies with molecular modulators, studies into the combination of pre/post conditioning (P/P) were conducted on cell monolayers. These P/P studies included both apoptotic inhibition and oxidative stress modulation studies. As detailed below, the P/P conditioning strategy resulted in a marked improvement in overall cell survival and repopulation in a number of conditions. Most notably, caspase 8 P/P conditioning in combination with U10G10 CP solution achieved about 80% cell survival.

With the establishment of less than 50% 24 hour endothelial cell survival following cryopreservation, the impact of pre- and post-conditioning in the various cryopreservation solutions, and the marked improvement in survival in the Unisol+CPA conditions, analysis of the impact of caspase inhibition prior to freezing (PF) and during post-thaw recovery (PW) in combination (P/P) was conducted. As described in Example 2.1, a mitochondrial mediated apoptotic inhibitor (Caspase 9) and a membrane mediated apoptotic inhibitor (Caspase 8) were evaluated along with the pan-Caspase IV inhibitor.

For P/P conditioning studies, 1 hour prior to CP addition, culture media was decanted and 100 μL of fresh media supplement with Caspase 8, 9, or IV was added to each respective sample. Samples were then incubated at 37° C. for 1 hour, followed by media removal and addition of 100 μL of CP solution, and cryopreservation was conducted as described above. Following thawing, samples were diluted and incubated in media supplemented with caspase inhibitors for 24 hours recovery, then cell viability was assessed using the Calcein-AM assay.

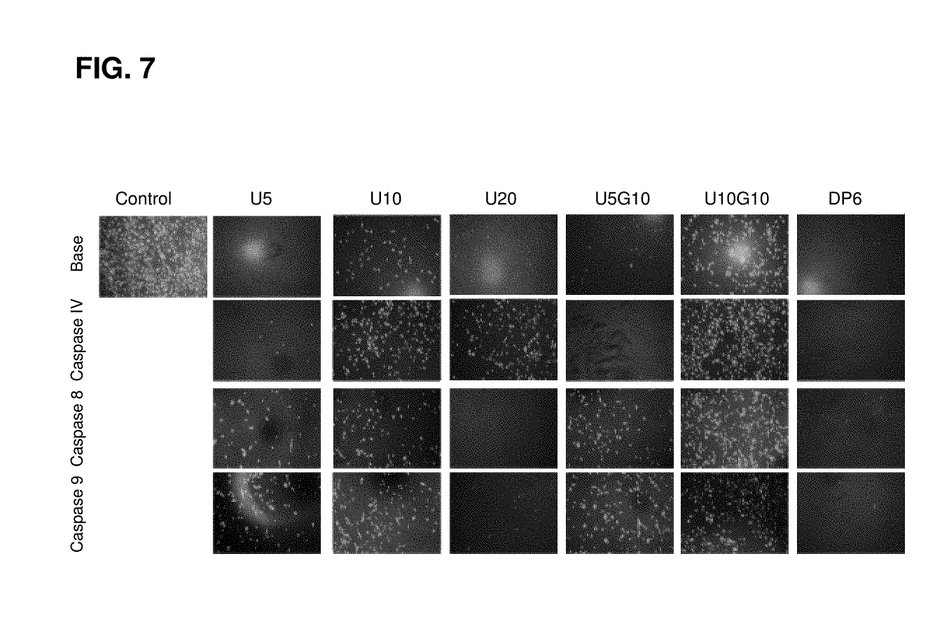

FIG. 7 illustrates the results of the assessment of apoptotic inhibition pre- and post-freeze conditioning on human endothelial cell survival 1 day following cryopreservation with and without reduced CPA. Fluorescent images indicate an improvement in cell survival in all of the Unisol+CPA samples (caspase 8, 9, and IV) compared to their non-treated matched samples. The greatest improvement in survival was noted in the U10G10 Caspase inhibition P/P sample where day 1 survival was found to be similar to pre-treatment controls.

In the case of the U10G10 solution, P/P with caspase inhibitors resulted in >60% survival, with caspase 8 P/P yielding >80% survival. It was also noted that while survival levels were lower than the U10G10 samples overall, P/P using caspase inhibitors in combination with U10 and U20 CP solutions resulted in a substantial increase in post-thaw viability compared to matched non-treated samples.

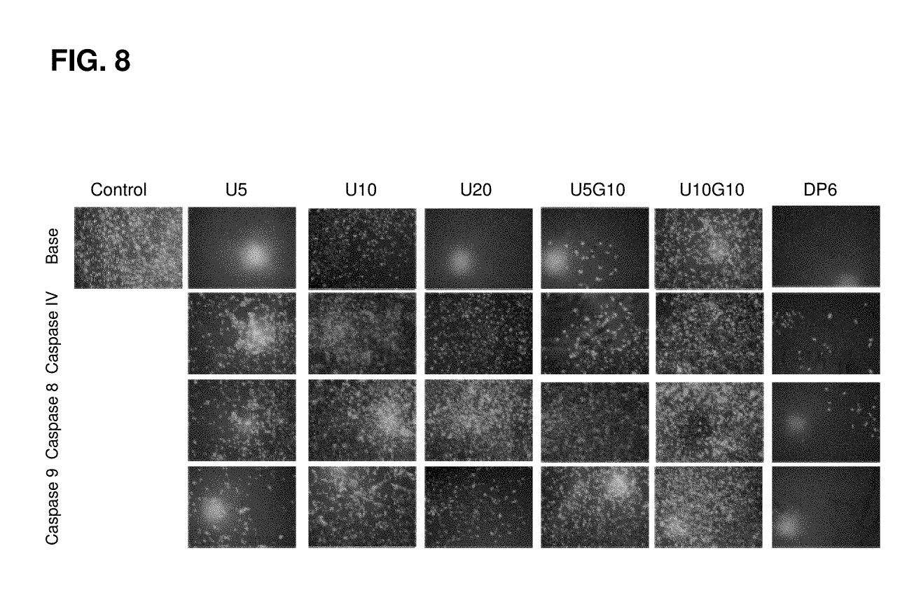

FIG. 8 illustrates the results of an assessment of the impact of apoptotic inhibition pre- and post-freeze conditioning on human endothelial cell repopulation 3 days following cryopreservation with and without reduced CPA. Images indicate a marked improvement in cell repopulation in the Unisol+CPA conditions following the dual pre- and post-treatment conditioning with Caspase inhibitors. Notably, Caspase 8 and 9 inhibition post-treatment appeared to be the most beneficial. However, the application of Caspase 8 inhibition alone results in a marked improvement in all solutions in day 3 recovery compared to non-treated samples yielding recovery to a monolayer by day 3 beyond that of pre-treatment controls. As with the non-treated U10G10 samples, all P/P caspase inhibition samples recovered to a monolayer beyond that of controls and other experimental conditions by day 3. This benefit was not observed in the DP6 samples (FIGS. 7-8).

Example 2.2 also included analysis of the impact on HEC survival following cryopreservation with supplementation with resveratrol, salubrinal, and n-acetyl cysteine (NAC) in a pre-freeze and post-thaw conditioning combination, in 6 different cryopreservation solutions. These studies paralleled the caspase modulation studies detailed above. While the above studies focused on apoptotic caspase inhibition, those described below focused on free radical scavenging (resveratrol), the unfolded protein response (salubrinal), and oxidative stress (NAC).

For P/P conditioning studies, 1 hour prior to CP addition, culture media was decanted and 100 μL of fresh media supplement with resveratrol, salubrinal, and NAC was added to each respective well. Samples were then incubated at 37° C. for 1 hour, followed by media removal and addition of 100 μL of CP solution to the sample. Samples were then and frozen as described above. Following thawing, samples were diluted and incubated in media supplemented with resveratrol, salubrinal, and NAC for 24 hours recovery, then cell viability was assessed.

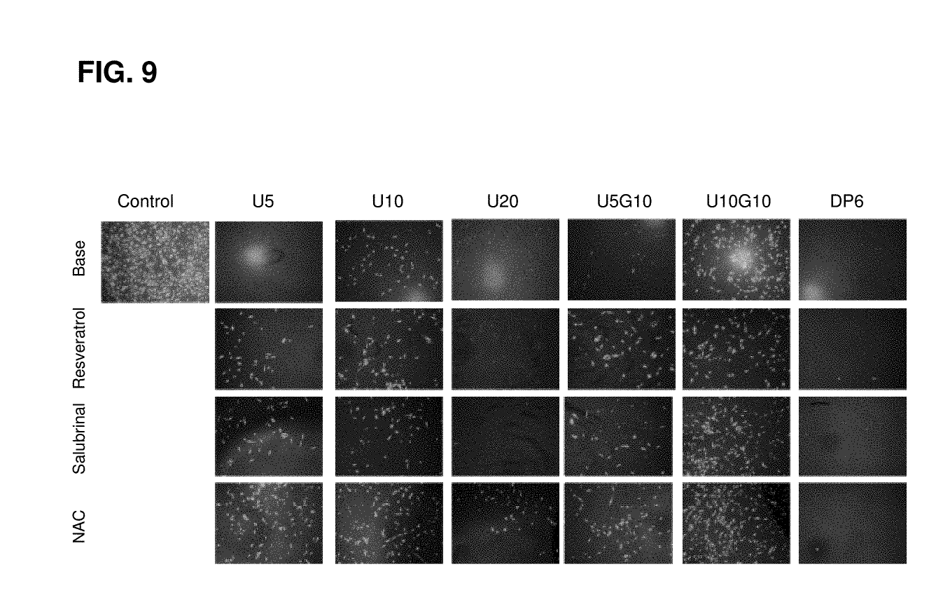

FIG. 9 illustrates the results of an assessment of the impact of oxidative stress modulators pre- and post-freeze conditioning on human endothelial cell survival 1 day following cryopreservation with and without reduced CPA. Monolayers of endothelial cells were pre-treated for 1 hour in culture media supplemented with inhibitors, frozen or vitrified in the indicated solutions, thawed, and placed into media with inhibitors for the initial 24 hours of recovery. Samples were then assessed for viability at 1 day post-thaw using the Calcein-AM assay. Fluorescent images indicate an improvement in cell survival in most of the Unisol+CPA P/P treatment samples compared to their non-treated matched samples. The greatest improvement in survival was noted in the U10G10 NAC P/P treated where day 1 survival was found to yield a ˜2.5 fold increase over that of non-treated samples (˜60% of non-treated controls).

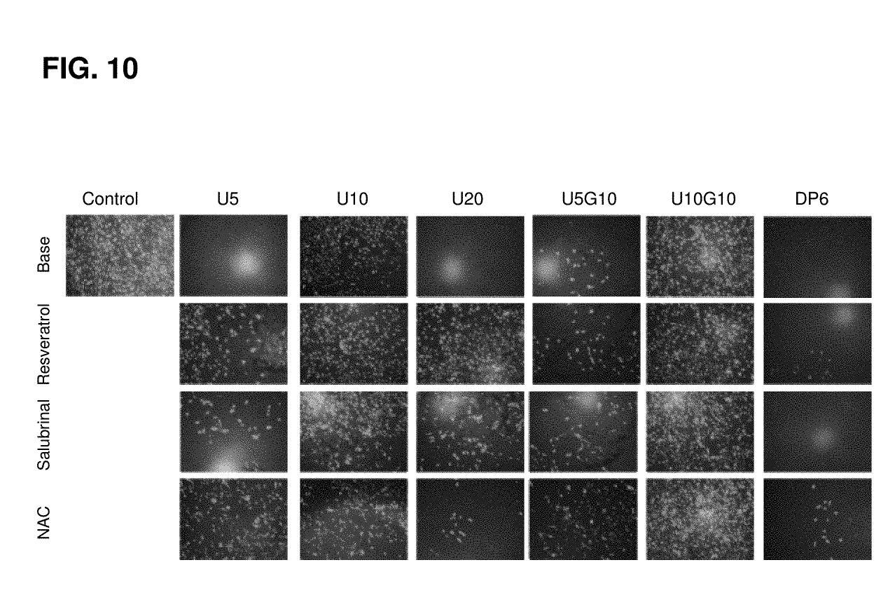

FIG. 10 illustrates the results of an assessment of the impact of oxidative stress modulator pre- and post-freeze conditioning on human endothelial cell repopulation 3 days following cryopreservation with and without reduced CPA. In the case of the U10G10 solution, P/P with inhibitors resulted in >50% survival with each of the agents (NAC, salubrinal, and resveratrol). While survival levels were lower than the U10G10 samples overall, P/P using resveratrol, salubrinal, and NAC in combination with U10 and U5G10 CP solutions resulted in an increase in post-thaw viability compared to matched non-treated samples. Analysis of sample recovery at 3 days post-thaw revealed complete monolayer formation in the U10G10 samples, beyond that of controls.

As noted, significant repopulation to ˜90% of controls (near monolayer) was noted in the U10 and U5G10 samples. As with the P/P caspase studies, this benefit was not seen in the DP6 samples, where minimal to no improvement in survival over the baseline non-treated samples was observed (FIGS. 9-10).

Overall, the P/P conditioning molecular modulation analysis confirmed the benefit in improving post-thaw cell survival and recovery in a number of conditions including various solutions, CPAs, CPA combinations, and CPA concentrations, as well as freeze and thaw protocols. This benefit was clearest when used in combination with the U10G10 solution. Specifically, when U10G10 was utilized with P/P using caspase 8 inhibitor nearly 90% cell survival following cryopreservation was obtained.

### Example 2.3

The following studies focus on analysis of the impact of the agents resveratrol, salubrinal and n-acetyl cysteine (NAC) supplementation as pre-freeze (PF) and post-thaw (PW) conditioning agents. These studies paralleled the caspase modulation studies detailed under Example 2.1. While Example 2.1 agents focused on apoptotic caspase inhibition, Example 2.3 agents focused on free radical scavenging (resveratrol), the unfolded protein response (salubrinal) and oxidative stress (NAC).

With the establishment of 24 hour endothelial cell survival following cryopreservation in the solutions as illustrated in Example 1, the impact of inclusion of resveratrol, salubrinal and NAC as PF conditioning agents was analyzed. As with the Example 2.1 and 2.2 studies, cell survival and repopulation was assessed by Calcein-AM assay and analyzed using fluorescent microscopy (Zeiss).

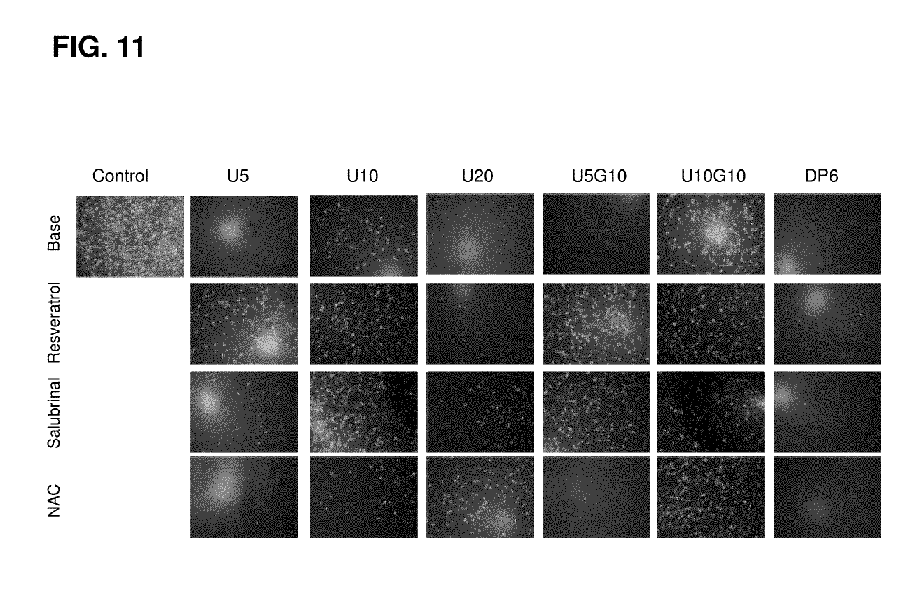

FIG. 11 illustrates the results of an assessment of the impact of oxidative stress modulators pre-freeze conditioning on human endothelial cell survival 1 day following cryopreservation with and without reduced CPA. Endothelial cells were pre-treated for 1 hour in culture media supplemented with inhibitors, frozen or vitrified in the indicated solutions, thawed, diluted and placed into culture for the initial 24 hours of recovery. Samples were then assessed for viability at 1 day post-thaw using the Calcein-AM assay. As shown in FIG. 11, the fluorescent images indicate an improvement in cell survival in several of the pre-treated samples compared to their non-treated matched samples. The greatest improvement in survival was noted in the U10G10 resveratrol and NAC pre-treated samples, where day 1 survival was found to yield a ˜2 fold increase over that of non-treated samples. Improvement was also seen in the U10, U20, U5G10, and U10G10 salubrinal and resveratrol samples.

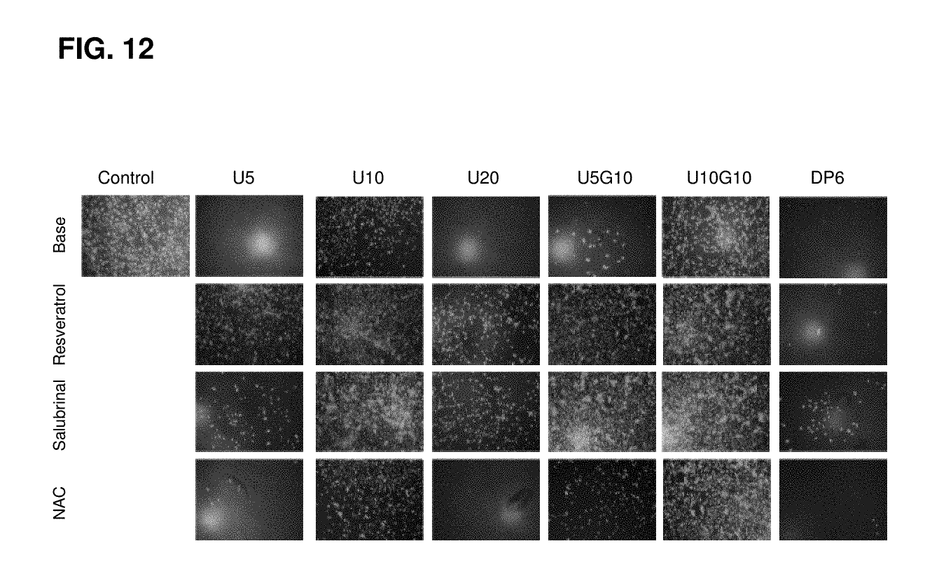

As shown in FIG. 12, which illustrates the results of an assessment of the impact of oxidative stress modulators pre-freeze conditioning on human endothelial cell repopulation 3 days following cryopreservation with and without reduced CPA, this increase in cell survival in the U10G10 conditions translated into improved cell recovery. Images indicate similar cell repopulation in the Unisol+CPA conditions following pre-treatment conditioning with the oxidative stress modulators compared to non-treated samples. The greatest improvement in repopulation was noted in the U10G10 pre-treated conditions, in which day 3 recovery reached a monolayer similar to non-treated samples and beyond that of controls. All U10G10 samples had repopulated to a monolayer by day 3. Unlike the caspase inhibitors, no apparent increase in retention of overall cell number was noted in any of the cryopreservation solutions evaluated, e.g., PF conditioning with DP6 did not result in any significant increase in cell survival or repopulation.

With the establishment of 24 hour endothelial cell survival following cryopreservation in the solutions (Example 1) and modest impact of pre-freeze conditioning (except for in the U10G10 samples), analysis of inclusion of resveratrol, salubrinal and NAC as PW conditioning agents in the Unisol+CPA samples as well as the DP6 was conducted.

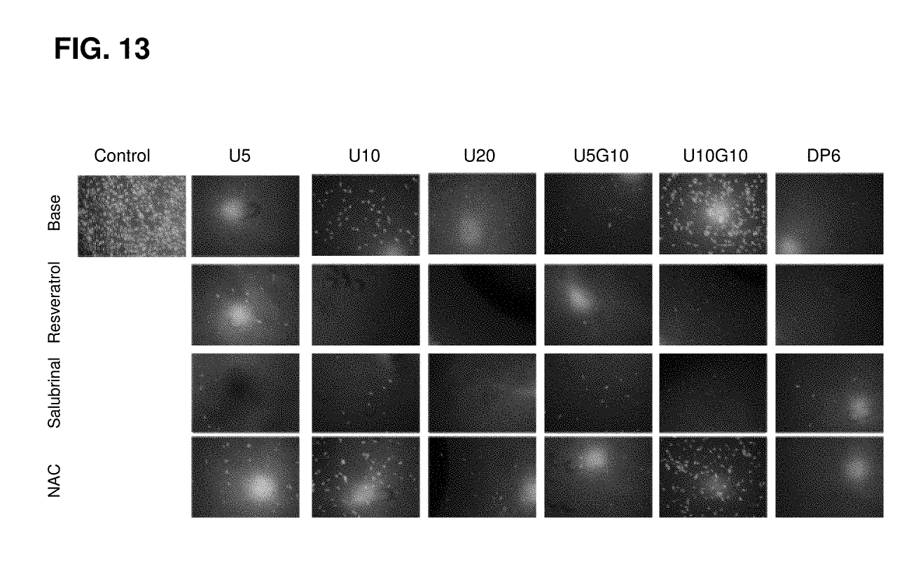

FIG. 13 illustrates the results of an assessment of the impact of oxidative stress modulators post-thaw conditioning on human endothelial cell survival 1 day following cryopreservation with and without reduced CPA. Endothelial cells were frozen or vitrified in the indicated solutions, thawed and placed into media supplemented with the indicated inhibitors for the initial 24 hours of recovery. Samples were then assessed for viability at 1 day post-thaw using the Calcein-AM assay. Little improvement in cell survival in several of the post-conditioned samples was observed compared to their non-treated matched samples. The greatest improvement in survival was noted in the U10G10 resveratrol and NAC post-conditioned samples, in which day 1 survival was found to yield a ˜2 fold increase over that of non-treated samples. This increase in cell survival in the NAC PW condition was seen in the U10 and U10G10 solutions and resulted in a ˜50% increase in survival.

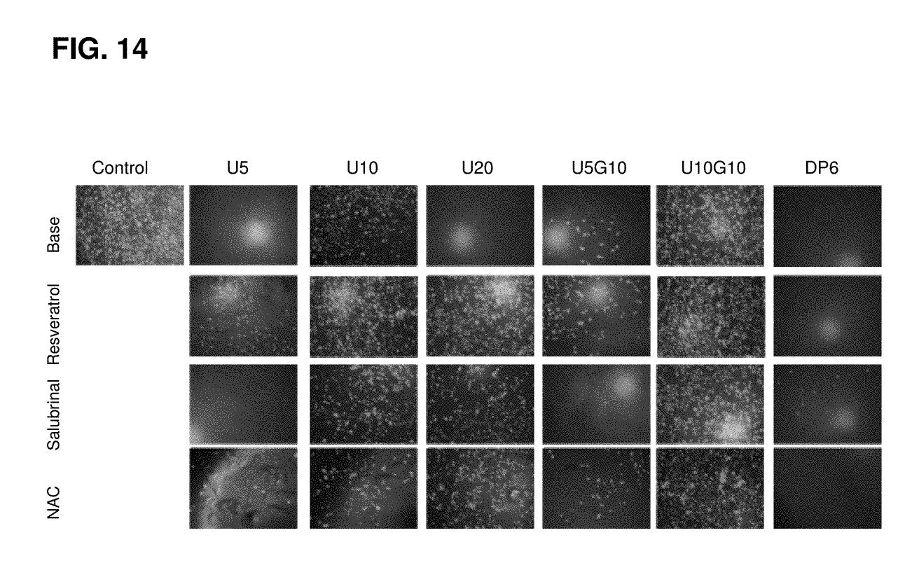

As shown in FIG. 14, the increases in survival in the NAC treated samples translated into improved cell recovery. FIG. 14 illustrates the results of an assessment of the impact of oxidative stress modulators post-thaw conditioning on human endothelial cell repopulation 3 days following preservation with and without reduced CPA. Endothelial cells were frozen or vitrified in the indicated solutions, thawed, and placed into media supplemented with the indicated inhibitors for the initial 24 hours of recovery, followed by standard media culture. Samples were then assessed for repopulation following 3 days of recovery using the Calcein-AM assay. Images indicate similar cell repopulation in the Unisol+CPA conditions following post-thaw conditioning (PW) with the oxidative stress modulators compared to non-treated samples. The greatest improvement in repopulation was noted in the U10G10 post-conditioning, in which day 3 recovery reached a monolayer similar to non-treated samples and beyond that of controls. Improvements in cell recovery were also noted in the U10 and U20 post-thaw conditioning samples, whereas no benefit was seen in the U5G10 condition. As with the pre-freeze conditioning, the PW conditioning with DP6 did not result in any significant increase in cell survival or repopulation.

Overall, the resveratrol, salubrinal and NAC pre-freeze and post-thaw conditioning molecular modulation analysis revealed benefit in improving post-thaw cell survival or recovery primarily in the U10G10 solution. Broader solution benefit was also observed with NAC post-warming conditioning when used in combination with various solutions, CPAs, CPA combinations, and CPA concentrations, as well as freeze and thaw protocols.

### Example 3: Smooth Muscle Cells

### Example 3.1

The study described in example 3.1 focuses on the collection of cell survival data and the impact of post-thaw conditioning on human smooth muscle cells (SMCs). Specific activities included application of the high throughput monolayer sample cryopreservation protocol and collection of data (survival and cell death) from samples frozen using 6 unique cryopreservation solutions (U5, U10, U20, U5G10, U10G10, DP6) and 6 unique modulators (resveratrol, salubrinal, caspase inhibitors (IV, 8, 9) and NAC). Survival was determined at 24 hours post-thaw to allow for the manifestation of any delayed onset cell death pathways to be executed. Further, cell recovery was included to evaluate the long term potency and repopulation potential of the various samples.

A series of experiments was conducted to evaluate the performance of several solutions (U5, U10, U20, U5G10, U10G10 and DP6) as well as the impact of pre-freeze (PF) and post-warming (PW) conditioning with the apoptotic inhibitors Caspase 8, Caspase 9 and Caspase IV inhibitors. Cell samples were processed using the monolayer CP protocol and analyzed following 24 hours to 7 days post thaw for survival and recovery. These experiments were conducted to evaluate the impact of molecular modulators (inhibitors) during pre-freeze or post-thaw recovery on cell survival when added to the media 1 hour prior to or 24 hour following cryopreservation. Experimentation built upon the endothelial cell results in examples 2.1 to 2.3, and focused on survival analysis based on cellular plating and re-growth using the cell membrane integrity assay Calcein-AM which fluorescently assesses cell membrane integrity and intracellular enzymatic esterase activity. To this end, samples were probed with Calcein-AM, incubated for 30 mins in the dark and then imaged using a Zeiss Axiovert 200 fluorescence microscope and Axiovision software. Images were taken at 24 hours to 7 days post-thaw to allow for assessment of solution and post-thaw conditioning agent performance.

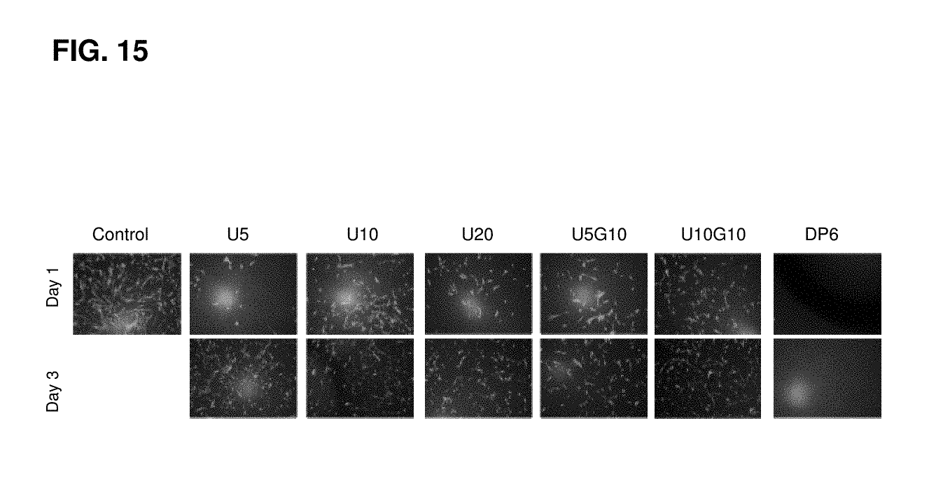

FIG. 15 illustrates the results of an assessment of human smooth muscle cell survival following cryopreservation in Unisol-based solutions with and without reduced CPA. Smooth muscle cells were frozen or vitrified and thawed in the indicated solutions. Following thawing, samples were placed into culture and assessed for viability at 1 day (24 hours) post-thaw and following 3 days of recovery using the Calcein-AM assay. As expected, control (non-frozen) samples revealed a high number of green fluorescent cells indicating a healthy culture. Analysis indicates that the Unisol+CPA solutions provided for improved survival and repopulation compared to the cryopreservation solution DP6. Most notably, the U10G10 condition yielded about 45% survival and repopulated to near pre-freeze controls within 3 days. Analysis of the samples frozen using DP6 revealed minimal smooth muscle cell survival. This was consistent with findings in endothelial cells. In the smooth muscle cell monolayer configuration, the DP6 sample showed cell survival of less than 5% at 24 hours and did not recover by day 3 (FIG. 15, DP6).

Because the use of Unisol+CPA was found to be beneficial in the endothelial cell model, studies were conducted investigating the impact of Unisol as the base solution supplemented with various CPAs on smooth muscle cells (SMCs). Specifically, 5% (U5), 10% (U10), and 20% (U20) DMSO, 5% DMSO+10% Glycerol (U5G10) and 10% DMSO+10% Glycerol (U10G10) were added to Unisol and evaluated. The use of Unisol as the carrier solution supplemented with CPAs resulted in a marked improvement in cell survival compared to any of the commercially available cryopreservation solutions tested. While the U5 and U10 variant yielded modest survival, the U10, U5G10 and U10G10 yielded elevated survival above any of the other conditions. (FIG. 15) Most notably, the U10G10 solution resulted in a marked increase in cell survival to ˜50% compared to non-frozen controls (FIG. 15, U10G10). This represented a marked increase in day 1 survival over the DP6 condition. Additionally, the U10 and U5G10 conditions also yielded improved survival over the DP6 condition.

As in previous experiments, the 24 hour time point was used for initial survival assessment, as this time point allows for the manifestation of molecular based cell stress-induced death. This provides a more accurate measure of survival than 0 or 1 hour post-thaw assessment, as is typically used. The 3 day time point was selected to assess re-population potential of any surviving cells as an indicator of long term potency. The 3 day post-thaw recovery interval was necessary due to the elevated survival in the Unisol conditions, where cell recovery and monolayer formation was more rapid than the less effective conditions.

With the establishment of less than 5% 24 hour smooth muscle cell survival following cryopreservation in DP6 and the marked improvement in survival in the Unisol+CPA conditions, analysis of the impact of caspase inhibition prior to freezing (PF) and during post-thaw recovery (PW) was conducted. A mitochondrial-mediated apoptotic inhibitor (Caspase 9) and membrane-mediated apoptotic inhibitor (Caspase 8) were used to evaluate the involvement and impact of modulation of various apoptotic induction pathways. Additionally a pan-Caspase inhibitor (Cas IV) was also used to assess the impact of global pathway modulation. As with the viability studies above, cell survival and repopulation were assessed using Calcein-AM and fluorescent microscopy (Zeiss).

For smooth muscle cell pre-freeze (PF) conditioning studies, 1 hour prior to CP addition, culture media was decanted and 100 μL of fresh media supplemented with caspase 8, 9, or IV was added to each respective well. Samples were then incubated at 37° C. for 1 hour, followed by media removal and addition of 100 μL of CP solution to samples followed by cryopreservation as described above. Following preservation, samples were thawed, diluted, and placed into culture. Following 24 hours recovery, cell viability was assessed.

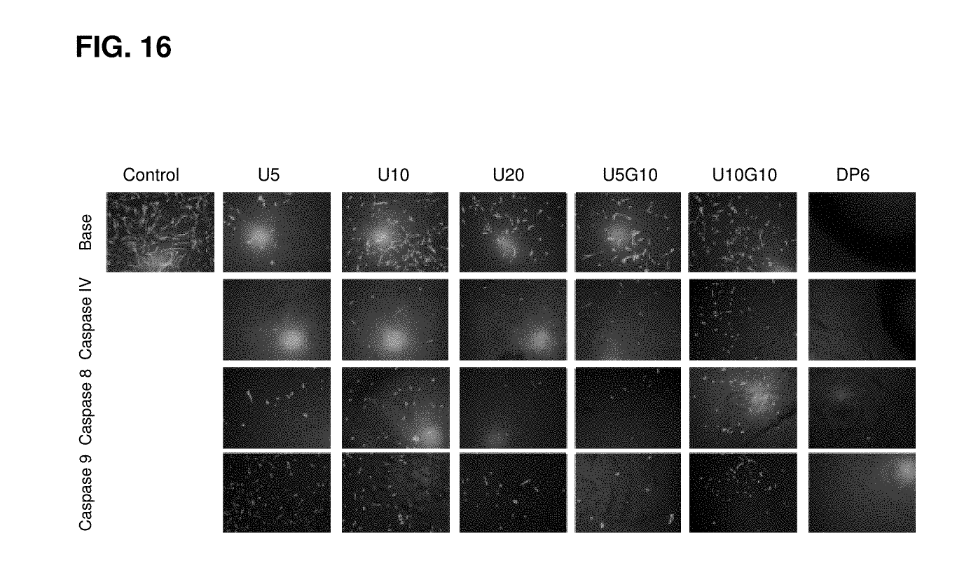

FIG. 16 illustrates the impact of apoptotic inhibition pre-freeze conditioning on human smooth muscle cell survival 1 day following cryopreservation with and without reduced CPA. Images indicate minimal improvement in survival in the Unisol+CPA conditions when pretreated with Caspase inhibitors. U10G10 again provided the best survival, and PF conditioning alone provided no significant benefit.

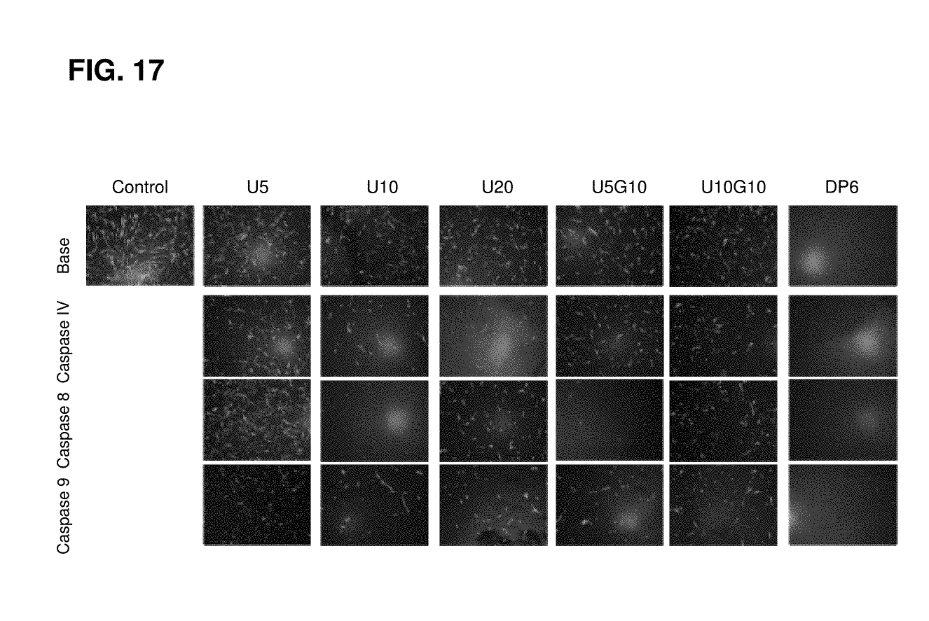

FIG. 17 illustrates the impact of apoptotic inhibition pre-freeze conditioning on human smooth muscle cell repopulation 3 days following cryopreservation with and without reduced CPA. A minimal improvement in recovery was observed in the Unisol+CPA conditions when pretreated with Caspase inhibitors.

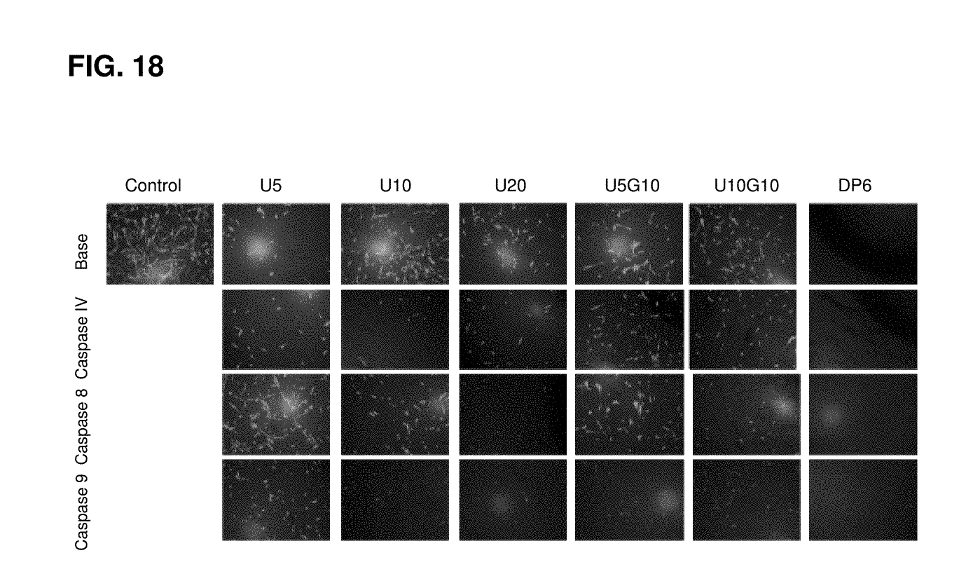

For smooth muscle cell post-warming (PW) conditioning studies, following thawing and cryopreservation, CP solution was removed or diluted with culture media supplemented with caspase 8, 9, or IV. FIG. 18 illustrates the impact of apoptotic inhibition post-freeze conditioning on human smooth muscle cell survival 1 day following cryopreservation with and without reduced CPA. Fluorescent images indicate no significant improvement in cell survival in any of the samples compared to their non-treated matched samples. Images again indicate an initial improvement in survival in the Unisol+CPA conditions but revealed no substantial benefit for post-treatment with caspase inhibitors following 1 day recovery. As with endothelial cells, U10G10 provided the best overall survival. The PW conditioning of the Unisol+CPA solutions with Caspase 8 inhibitor resulted in a slight increase in cell survival over both the non-conditioned and PF conditioned samples.

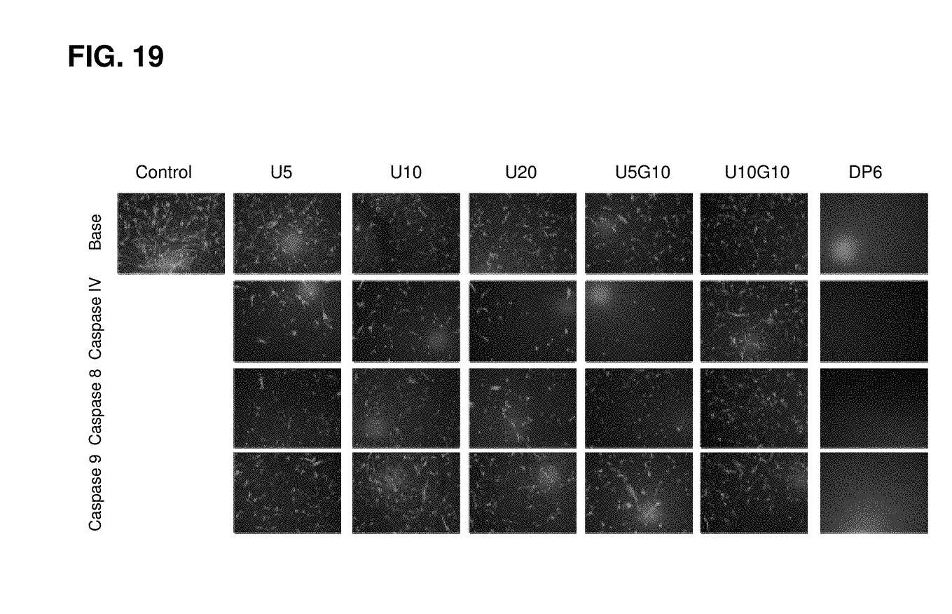

As shown in FIG. 19, analysis of sample recovery at 3 days post-thaw revealed that the observed increase in survival in the U10, U5G10 and U10G10 Caspase 8 and 9 samples in FIG. 18 translated to increased cell repopulation over a three day recovery period yielding a cell monolayer in several of the conditions. Post-thaw conditioning in caspase 8 yielded complete recovery of the samples to pre-freeze controls by Day 3. This was a marked improvement over the best recovery achieved with DP6 with post-thaw conditioning using caspase inhibition where after 3 days, minimal recovery was observed. Assessment of Caspase 9-conditioned samples also revealed improvement over non-conditioned control samples. The improvement in smooth muscle cell recovery using post-thaw conditioning in Caspase inhibitors was consistent with the findings reported for the endothelial cell model, which supports mainstream use on tissues and organs, and across various cell types.

Overall, the caspase inhibitor pre-freeze and post-thaw conditioning molecular modulation analysis conducted revealed that the use of caspase inhibition (specifically Caspase 8 inhibitor) resulted in an improvement in smooth muscle cell recovery and repopulation following cryopreservation in the U10G10 solution as well as yielded an improvement in cell number post-thaw in several of the solutions including various solutions, CPAs, CPA combinations, CPA concentrations as well as freeze and thaw protocols evaluated (U5, U10 and U5G10).

### Example 3.2

With the establishment of benefit of pre- and post-conditioning with molecular modulators, studies into the combination of pre/post conditioning (P/P) were conducted on smooth muscle cells. These P/P studies included both apoptotic inhibition and oxidative stress modulation studies. As detailed below, the P/P conditioning strategy resulted in a marked improvement in overall cell survival and repopulation in a number of conditions.

With the establishment of less than 50% 24 hour smooth muscle cell survival following cryopreservation and the impact of pre- and post-conditioning in the various cryopreservation solutions and the marked improvement in survival in the Unisol+CPA conditions, analysis of the impact of caspase inhibition prior to freezing (PF) and during post-thaw recovery (PW) in combination (P/P) was conducted. As previously described, a mitochondrial-mediated apoptotic inhibitor (Caspase 9) and a membrane-mediated apoptotic inhibitor (Caspase 8) were evaluated along with the pan-Caspase IV inhibitor.

For P/P conditioning studies, 1 hour prior to CP addition, culture media was decanted and 100 μL of fresh media supplement with caspase 8, 9, or IV was added to each respective well. Samples were then incubated at 37° C. for 1 hour, followed by media removal and addition of 100 μL of CP solution and frozen as described above. Following storage, samples were thawed, diluted and incubated in media supplemented with caspase inhibitors for 24 hours recovery and then cell viability was assessed.

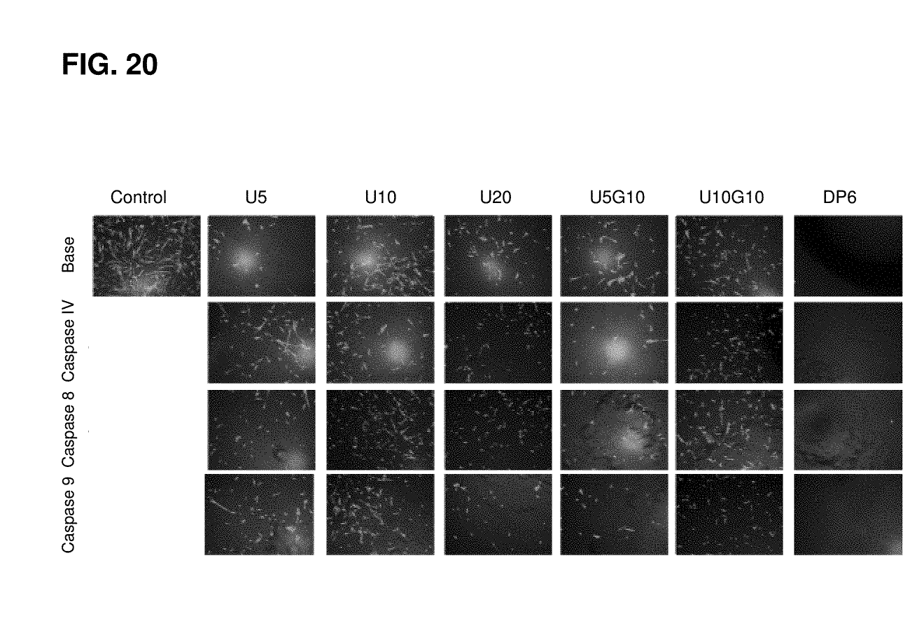

FIG. 20 illustrates the impact of apoptotic inhibition pre- and post-freeze conditioning on human smooth muscle cell survival 1 day following cryopreservation with and without reduced CPA. Fluorescent images indicate an improvement in cell survival in all of the Unisol+CPA samples compared to their non-treated matched samples following Caspase P/P conditioning. The greatest improvement in survival was noted in the U10G10 Caspase 8 P/P samples where day 1 survival was found to be ˜60% of controls. This represented a ˜50% increase over non-treated P/P (no P/P treatment) U10G10 samples. It was also noted that while survival levels were lower than the U10G10 samples overall, P/P using caspase inhibitors in combination with the U10 solutions resulted in a substantial increase in post-thaw viability compared to matched non-treated samples.

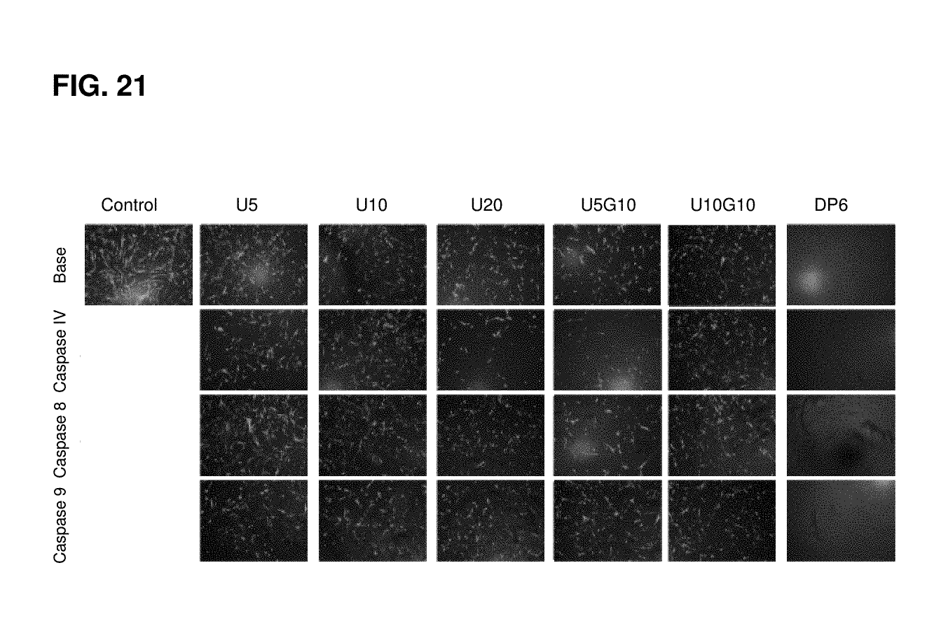

FIG. 21 illustrates the impact of apoptotic inhibition pre- and post-freeze conditioning on human smooth muscle cell repopulation 3 days following cryopreservation with and without reduced CPA. Images indicate a marked improvement in cell repopulation in the Unisol+CPA conditions following the dual pre- and post-treatment conditioning with Caspase inhibitors. Notably, the application of either Caspase 8 and 9 inhibition alone resulted in a marked improvement in day 3 recovery in all conditions compared to non-treated samples yielding recovery by day 3 approaching that of pre-treatment controls. As with the non-treated U10G10 samples, all P/P caspase inhibition samples recovered to near that of controls and other experimental conditions by day 3. This benefit was not seen in the DP6 samples, in which minimal to no improvement in survival over the baseline non-treated samples were observed (FIGS. 20 and 21).

Investigation into the impact of resveratrol, salubrinal and n-acetyl cysteine (NAC) supplementation in a pre-freeze and post-thaw conditioning combination on smooth muscle cell survival following cryopreservation paralleled the caspase modulation studies detailed above. While the above studies focused on apoptotic caspase inhibition, these studies focused on free radical scavenging (resveratrol), the unfolded protein response (salubrinal) and oxidative stress (NAC).

For P/P conditioning studies, 1 hour prior to CP addition, culture media was decanted and 100 μL of fresh media supplement with one of resveratrol, salubrinal and NAC was added to each respective well. Samples were then incubated at 37° C. for 1 hour, followed by media removal and addition of 100 μL of CP solution and then frozen as described above. Following storage, samples were thawed, diluted, and incubated in media supplemented with one of resveratrol, salubrinal or NAC for 24 hours recovery, then cell viability was assessed.

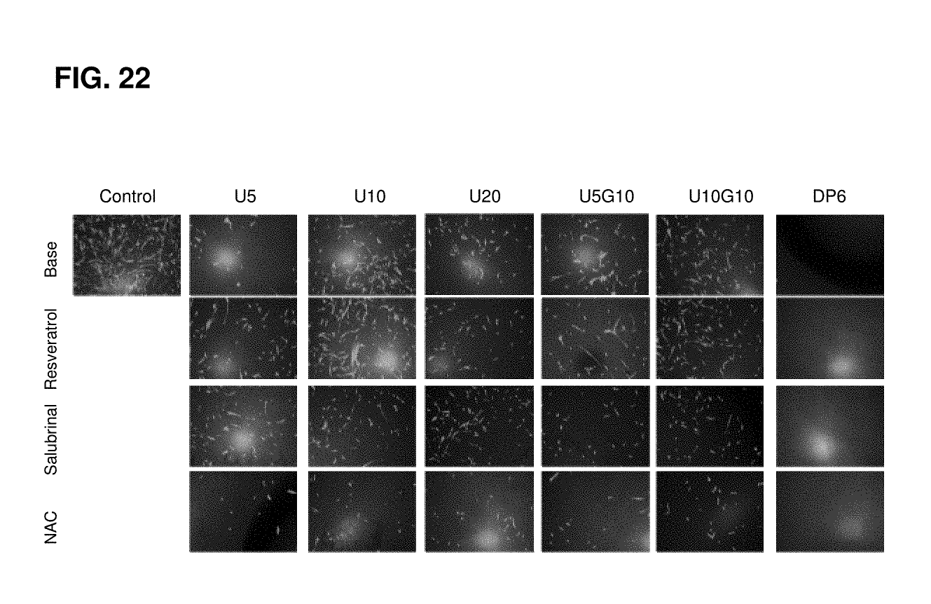

FIG. 22 illustrates the impact of oxidative stress modulators pre- and post-freeze conditioning on human smooth muscle cell survival 1 day following cryopreservation with and without reduced CPA. Fluorescent images indicate an improvement in cell survival in several of the Unisol+CPA P/P treated samples compared to their non-treated matched samples. Again, Unisol+CPA based solutions outperformed the commercial DP6 CP solution, and it was found that P/P conditioning with resveratrol, salubrinal and NAC resulted in a slight to no improvement in cell survival compared to non-conditioned samples.

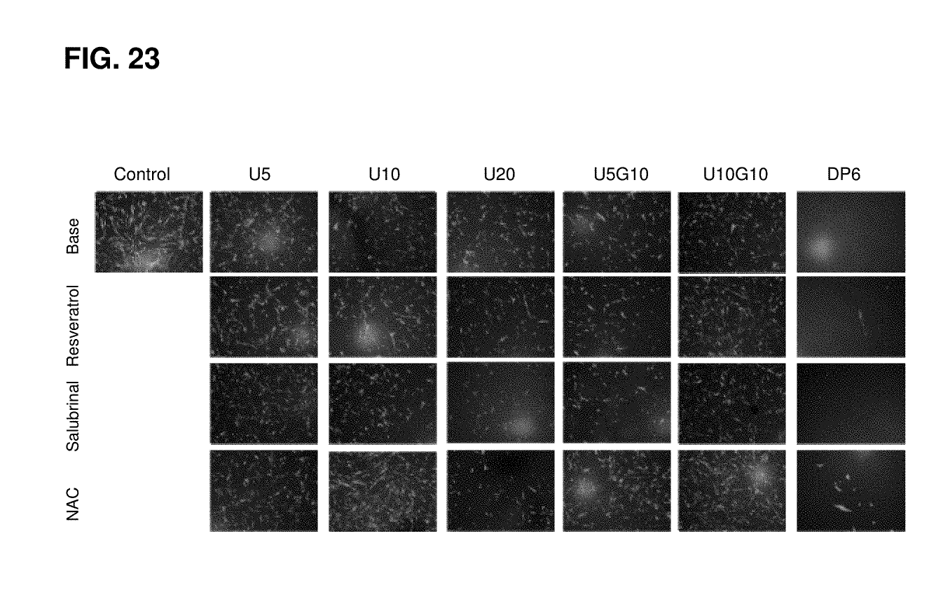

FIG. 23 illustrates the impact of oxidative stress modulators pre- and post-freeze conditioning on human smooth muscle cell repopulation 3 days following cryopreservation with and without reduced CPA. Images indicate an improvement in cell repopulation in the Unisol+CPA conditions following the dual pre- and post-treatment conditioning with the oxidative stress modulators. The greatest improvement in repopulation was noted in the P/P NAC treated samples (U10 and U10G10) where day 3 recovery reached a monolayer similar to non-treated controls. Analysis of sample recovery at 3 days post-thaw revealed complete recovery to that of controls in each of the U10G10 samples.

Significant repopulation to about 90% of controls was also noted in the U10 and U5G10 samples. As with the P/P caspase studies, this benefit was not seen in the DP6 samples, in which minimal to no improvement in survival over the baseline non-treated samples was observed. (FIGS. 22 and 23)

Overall, the P/P conditioning molecular modulation analysis studies confirmed the benefit to post-thaw smooth muscle cell survival and recovery in a number of conditions including various solutions, CPAs, CPA combinations, and CPA concentrations, as well as freeze and thaw protocols. As was seen in the endothelial cell studies, this benefit was clearest when used in combination with the U10G10 solution. Specifically, when U10G10 was used with P/P using caspase 8 inhibitor, nearly 70% cell survival following cryopreservation was observed.

### Example 3.3

The following studies analyzed smooth muscle cell survival following cryopreservation in 6 different solutions with and without various molecular modulators applied in a pre-freeze and post-thaw conditioning setting. These studies focused on analysis of the impact of the agents resveratrol, salubrinal and n-acetyl cysteine (NAC) supplementation as pre-freeze and post-thaw conditioning agents. These studies paralleled the caspase modulation studies detailed in example 3.1. While the agents of example 3.1 focused on apoptotic caspase inhibition, example 3.3 agents focus on free radical scavenging (resveratrol), the unfolded protein response (salubrinal) and oxidative stress (NAC). As detailed in example 3.2, studies were also completed on analysis of pre/post conditioning using these agents.

Using the previously-described findings of FIG. 15 as a starting point, analysis of inclusion of resveratrol, salubrinal and NAC as PF conditioning agents was conducted. As with the example 3.1 and 3.2 studies, cell survival and repopulation was conducted using Calcein-AM and analyzed using fluorescent microscopy (Zeiss).

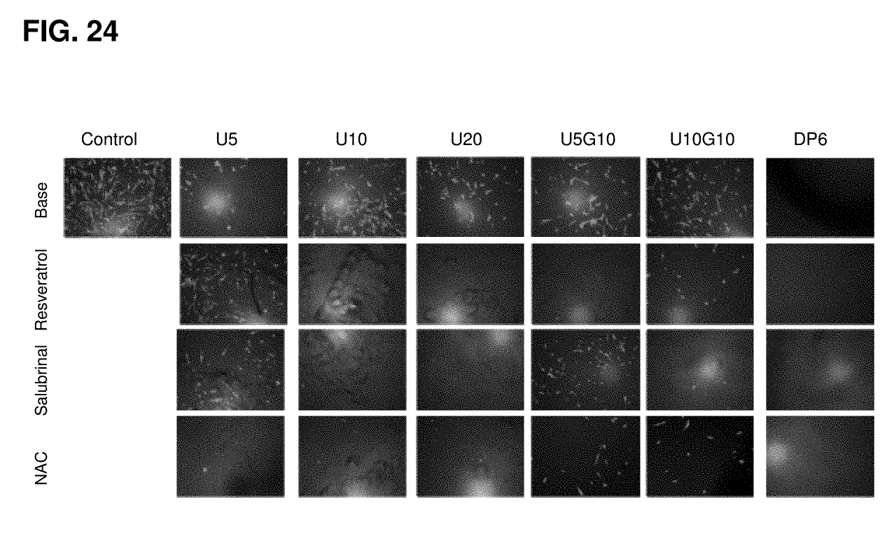

FIG. 24 illustrates the impact of oxidative stress modulators pre-freeze conditioning on human smooth muscle cell survival 1 day following cryopreservation with and without reduced CPA. Fluorescent images indicate no significant improvement in cell survival in pre-treated samples compared to their non-treated matched samples. Sample analysis at 24 hours post-thaw revealed a decrease in cell survival in all the cryopreservation solutions evaluated compared to non-pre-conditioned samples.

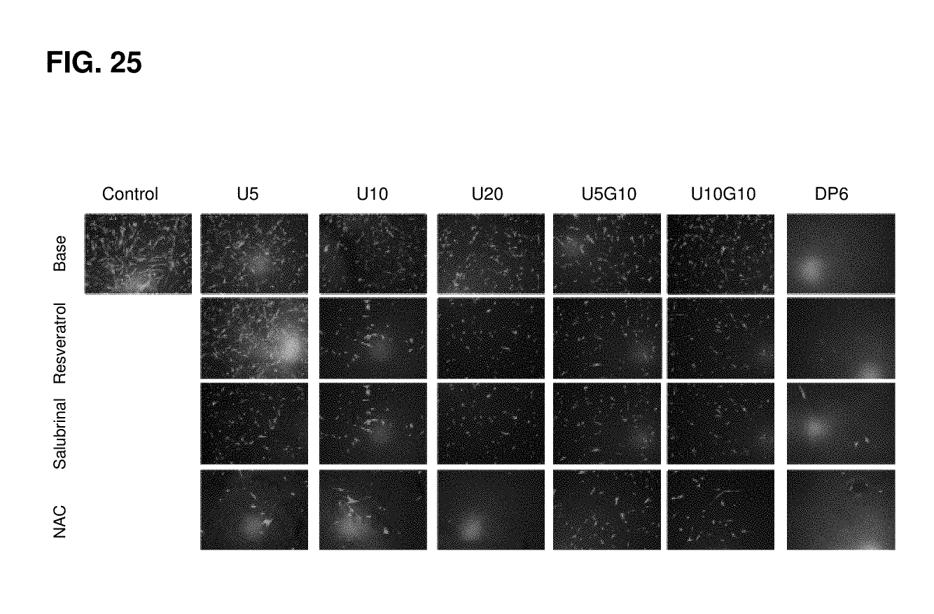

This decrease in cell survival (FIG. 24) was found to translate to a decrease in cell recovery at day 3 compared to non-treated samples (FIG. 25). This differed from the endothelial cell pre-treatment study results. FIG. 25 illustrates the impact of oxidative stress modulators pre-freeze conditioning on human smooth muscle cell repopulation 3 days following cryopreservation with and without reduced CPA. Overall images indicate reduced cell repopulation in the Unisol+CPA conditions following pre-treatment conditioning with the oxidative stress modulators compared to non-treated samples.

With the establishment of 24 hour smooth muscle cell survival following cryopreservation in the solutions as illustrated in FIG. 15 and discussed above, and the negative impact of pre-freeze conditioning (FIG. 25), inclusion of resveratrol, salubrinal and NAC as PW conditioning agents was investigated in the Unisol+CPA samples as well as the DP6.

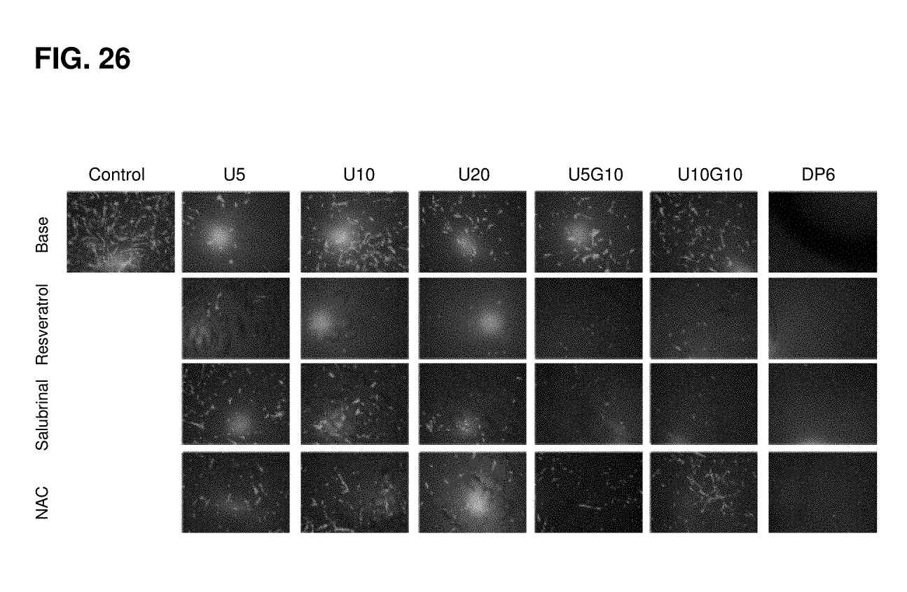

FIG. 26 illustrates the impact of oxidative stress modulators post-thaw conditioning on human smooth muscle cell survival 1 day following cryopreservation with and without reduced CPA. An improvement in cell survival in the NAC post-conditioned samples was observed compared to their non-treated matched samples. This was seen across various solutions, CPAs, CPA combinations, and CPA concentrations, as well as freeze and thaw protocols. The greatest improvement in survival was noted in the U10G10 NAC post-conditioned samples. Improvement was also seen in the U10 and U5G10 NAC samples. However, minimal benefit was seen in the salubrinal treated samples. This increase in cell survival in the NAC PW condition was seen in the U10 and U10G10 solutions.

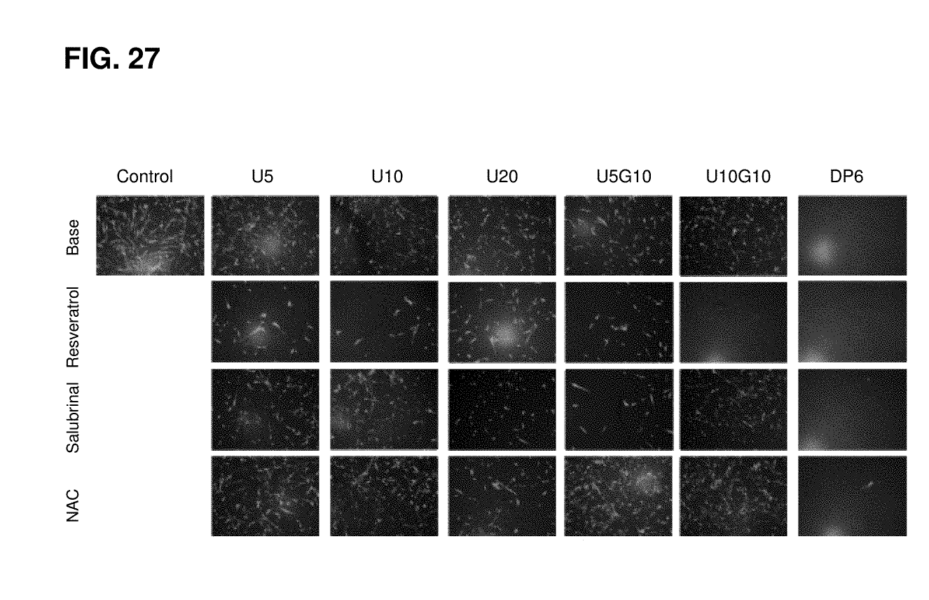

The increases in survival in the NAC treated samples (FIG. 26) translated into improved cell recovery. As shown in FIG. 27, by day 3 the U10G10 samples had repopulated to control levels, and the U10 and U5G10 had proliferated to a similar extent. FIG. 27 illustrates the impact of oxidative stress modulators post-thaw conditioning on human smooth music cell repopulation 3 days following cryopreservation with and without reduced CPA. Images indicate similar cell repopulation in the Unisol+CPA conditions following post-thaw conditioning with the oxidative stress modulators compared to non-treated samples. The greatest improvement in repopulation was noted in the U10G10 NAC post-conditioning samples where day 3 recovery reached a monolayer similar to non-treated samples and beyond that of controls. Improvements in cell recovery was also noted in the U10 and U5G10 post-thaw conditioned samples.

As with the pre-freeze conditioning, it was noted in FIGS. 26-27 that the post-thaw conditioning strategy with the commercial cryopreservation solution DP6 did not result in any significant increase in cell survival or repopulation.

Overall, the resveratrol, salubrinal and NAC pre-freeze and post-thaw conditioning molecular modulation analysis conducted with the smooth muscle cell model revealed benefit in improving post-thaw cell survival or recovery primarily in the U10G10 solution. Broader solution benefit was also observed with NAC post-warming (PW) conditioning when used in combination with the other solutions, CPAs, CPA combinations, and CPA concentrations, as well as freeze and thaw protocols.

### Example 4: Human Hematopoietic Stem Cells

The studies described in example 4 focus on the collection of cell survival data and the impact of post-thaw conditioning on human stem cells (hHSCs). Specific activities included standard cryopreservation protocol and collection of data (survival and cell death) from samples frozen using 6 unique cryopreservation solutions (Media, M5, M10, Unisol, U5 and U10) and 4 unique modulators (resveratrol (OSI), salubrinal (UPRI), caspase inhibitor (AI) and NAC). Survival was determined at 24 hours post-thaw to allow for the manifestation of any delayed onset cell death pathways to be executed. Further, cell recovery was included to evaluate the long term potency and repopulation potential of the various samples.

A series of experiments was conducted to evaluate the performance of several solutions (media, M5, M10, Unisol, U5, and U10) as well as the impact of post-warming (PW) conditioning with the molecular modulators. Cell samples were processed using a standard controlled rate cooling suspension protocol and analyzed following 24 hours to 7 days post thaw for survival and recovery. These experiments were conducted to evaluate the impact of molecular modulators (inhibitors) during post-thaw recovery on cell survival when added to the media following cryopreservation. Experimentation built upon the endothelial cell results in example 2, and focused on survival analysis based on cellular plating and re-growth using the cell membrane integrity assay Calcein-AM, which fluorescently assesses cell membrane integrity and intracellular enzymatic esterase activity. To this end, samples were probed with Calcein-AM, incubated for 30 mins in the dark and then imaged using a Zeiss Axiovert 200 fluorescence microscope and Axiovision software. Images were taken at 24 hours to 7 days post-thaw to allow for assessment of solution and post-thaw conditioning agent performance.

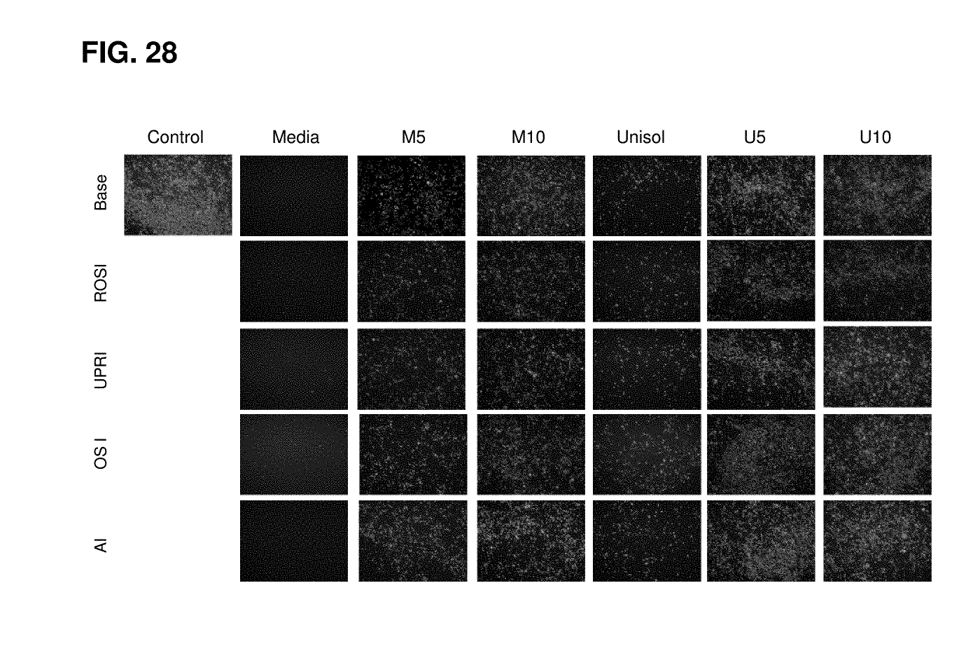

FIG. 28 illustrates human stem cell survival following cryopreservation in media and Unisol-based solutions with and without reduced CPA. hHSC cell suspensions were frozen, thawed, then diluted and incubated in the indicated solutions. Following thawing, samples were placed into culture and assessed for viability at 1 day (24 hours) post-thaw using the Calcein-AM assay. As expected, control (non-frozen) samples revealed a high number of green fluorescent cells indicating a healthy culture. Analysis indicates that the Unisol+CPA solutions provided for improved survival and repopulation compared to the standard cryopreservation solution media+DMSO. This was consistent with findings in endothelial cells.

Because the use of Unisol+CPA was found to be beneficial in the endothelial cell model, studies were conducted investigating the impact of Unisol as the base solution supplemented with various CPAs on human stem cell (hHSCs). Specifically, 5% (U5) and 10% (U10) were added to Unisol and evaluated. The use of Unisol as the carrier solution supplemented with the CPAs resulted in a marked improvement in cell survival compared to any of the commercially available cryopreservation solutions tested.

With the establishment of 24 hour human stem cell survival following cryopreservation, analysis of the impact of apoptotic (Caspase IV), oxidative stress (NAC), free radical (resveratrol) and unfolded protein response (salubrinal) inhibitor during post-thaw recovery (PW) was conducted. As with the viability studies above, cell survival and repopulation were assessed using Calcein-AM and fluorescent microscopy (Zeiss).

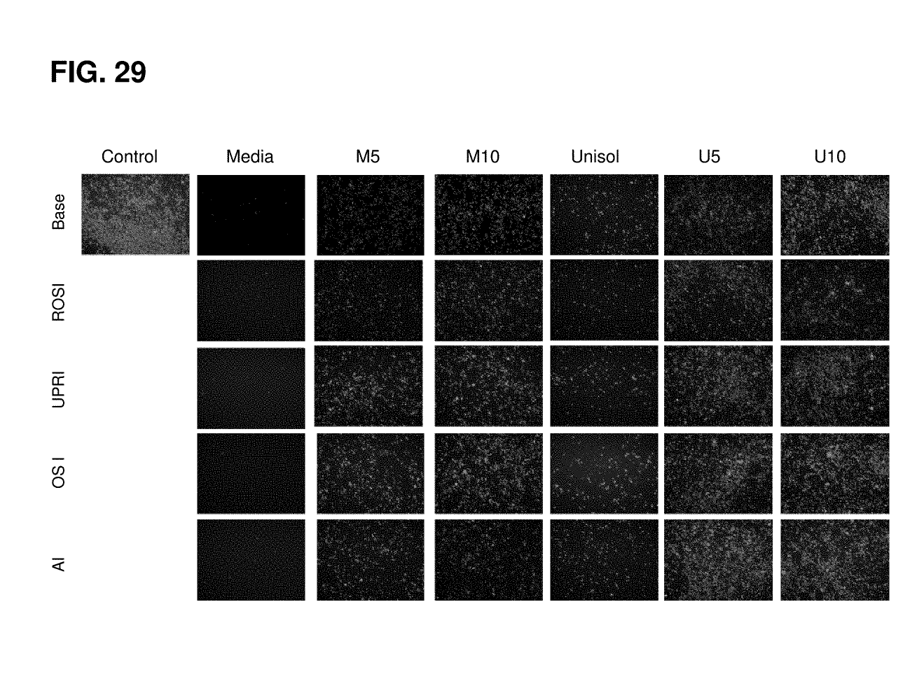

For hHSC post-warming (PW) conditioning studies, following thawing each sample was diluted with culture media supplemented with the respective molecular modulator added to the dilution media. Samples were incubated in culture for 24 hours, then assessed. The data in FIG. 28 illustrate the improvement in post-thaw survival of hHSC's following PW conditioning compared to non-modulated (Base) samples. This protective benefit was seen regardless of whether the thawing process was conducted using standard 37° C. water bath thawing (FIG. 28) or using dry thawing devices (FIG. 29). This benefit was also seen across various solutions, CPAs, CPA combinations, and CPA concentrations, as well as freeze and thaw protocols.

### Example 5: Human Liver Cells

The studies described in example 5 focus on the collection of cell survival data and the impact of post-thaw conditioning on human liver cells. Specific activities included standard cryopreservation protocol and collection of data (survival and cell death) from samples frozen using 4 unique cryopreservation solutions (Media with 0, 2, 5 and 10% DMSO) and 2 unique modulators (caspase inhibitor (CIV) and NAC). Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard controlled rate suspension freeze protocols and analyzed following 24 hours to 7 days post-thaw for survival and recovery. These experiments were conducted to evaluate the impact of molecular modulators (inhibitors) during post-thaw recovery on cell survival when added to the dilution media following cryopreservation. Experimentation built upon the endothelial cell results in example 2, and focused on survival analysis based on cellular plating and re-growth using the metabolic activity assay AlamarBlue, which fluorescently assesses cell metabolism via mitochondrial activity. To this end, samples were probed with AlamarBlue® (AccuMed International, Inc., Chicago, Ill.) dye, incubated for 60 mins in the dark, and then assessed using a Tecan micro plate reader. Assessment of survival was conducted at 24 hours post-thaw to allow for assessment of solution and post-thaw conditioning agent performance.

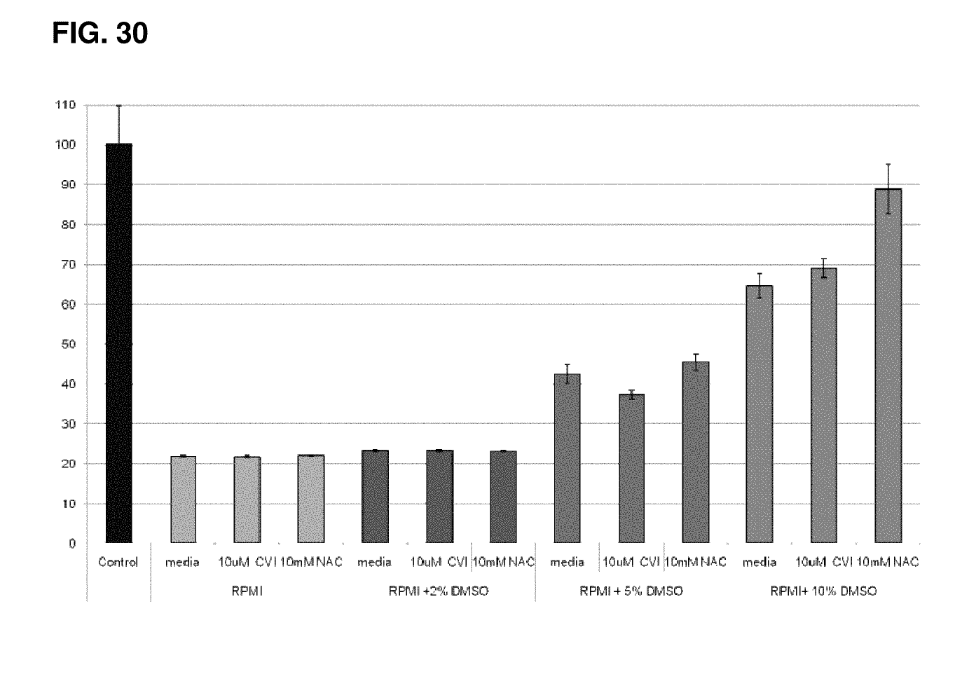

FIG. 30 illustrates the results of an assessment of human liver cell survival following cryopreservation in media-based solutions with various CPA concentrations. Liver cell suspensions were frozen, thawed, diluted, and incubated in the indicated solutions. Following thawing, samples were placed into culture and assessed for viability at 1 day (24 hours) post-thaw using the AlamarBlue assay. As expected, control (non-frozen) samples revealed a high number of cells indicating a healthy culture. Analysis indicates that the Media+CPA solutions provided for improved survival and repopulation based on the concentration of the CPA. This was consistent with findings in all other cell types.

With the establishment of 24 hour human liver cell survival following cryopreservation, analysis of the impact of apoptotic (Caspase IV), oxidative stress (NAC) inhibition during post-thaw recovery (PW) was conducted. As with the viability studies above, cell survival and repopulation were assessed using AlamarBlue.

For liver cell post-warming (PW) conditioning studies, following thawing the CP solution of each sample was diluted with culture media supplemented with the respective molecular modulator. Samples were incubated in culture for 24 hours, then assessed. The data in FIG. 30 illustrate the improvement in post-thaw survival of liver cells following PW conditioning compared to non-modulated samples. This protective benefit was seen regardless of whether the thawing process was conducted using standard 37° C. water bath thawing or using a dry thawing device. Further, this benefit was seen across various solutions, CPAs, CPA combinations, CPA concentrations, and freeze protocols.

### Example 6: Human Kidney Cells

The studies described in example 6 focus on the collection of cell survival data and the impact of post-thaw conditioning on human kidney cells. Specific activities included standard cryopreservation protocol and collection of data (survival and cell death) from samples frozen using 3 unique cryopreservation solutions (Media with 0, 2 and 5% DMSO) and oxidative stress modulation (NAC). Survival was determined at 24 hours post-thaw to allow for the manifestation of any delayed onset cell death pathways to be executed. Further, cell recovery was included to evaluate the long term potency and repopulation potential of the various samples.

Cell samples were processed a standard controlled rate suspension freeze protocols and analyzed following 24 hours to 3 days post thaw for survival and recovery. These experiments were conducted to evaluate the impact of molecular modulators (inhibitors) during post-thaw recovery on cell survival when added to the dilution media following cryopreservation. Experimentation built upon previous results in example 5, and focused on survival analysis based on cellular plating and re-growth using the metabolic activity assay AlamarBlue, which fluorescently assesses cell metabolism via mitochondrial activity. To this end, samples were probed with AlamarBlue, incubated for 60 mins in the dark and then assessed using a Tecan micro plate reader. Assessment was conducted at 24 hours post-thaw to allow for assessment of solution and post-thaw conditioning agent performance.

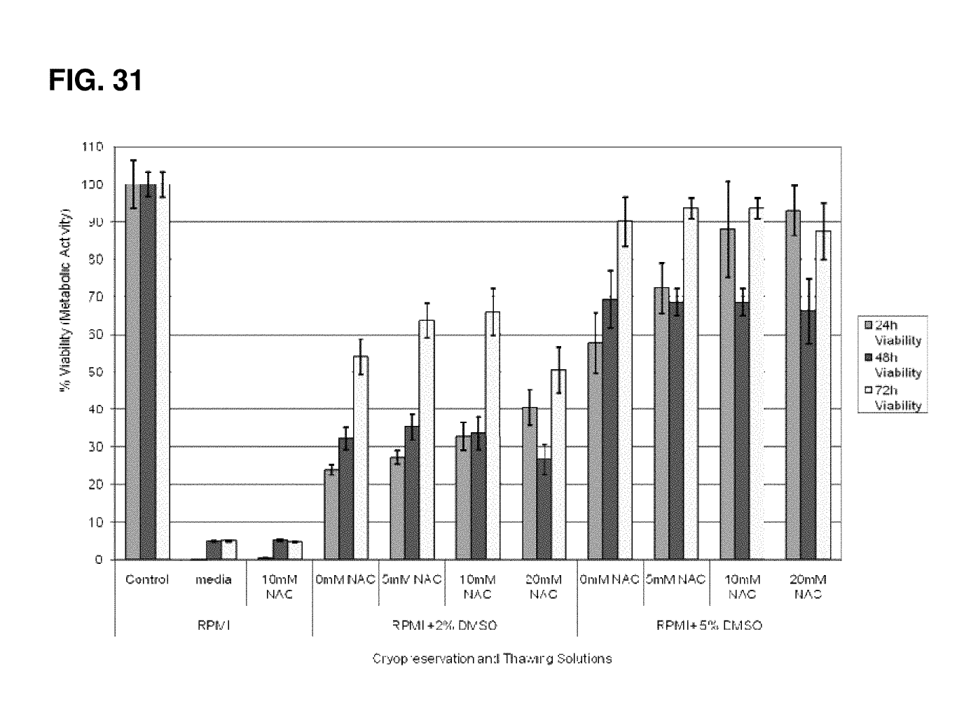

FIG. 31 illustrates the results of an assessment of human kidney cell survival following cryopreservation in media-based solutions with various CPA concentrations. Kidney cell suspensions were frozen and thawed in the indicated solutions. Following thawing, samples were placed into culture and assessed for viability at 1 day (24 hours) post-thaw using the AlamarBlue assay. As expected, control (non-frozen) samples revealed a high number of cells indicating a healthy culture. Analysis indicates that the Media (RPMI)+CPA solutions provided for improved survival and repopulation based on the concentration of the CPA. This was consistent with findings in all other cell types.

With the establishment of 24 hour human kidney cell survival following cryopreservation, analysis of the impact of oxidative stress (NAC) inhibition during post-thaw recovery (PW) was conducted. As with the viability studies above, cell survival and repopulation were assessed using AlamarBlue.

For kidney cell post-warming (PW) conditioning studies, following thawing, the CP solution of each sample was diluted with culture media supplemented with the respective molecular modulator. Samples were incubated in culture for 24 hours, then assessed. The data in FIG. 31 illustrate the improvement in post-thaw survival of kidney cells following PW conditioning compared to non-modulated samples. This protective benefit was seen regardless of whether the thawing process was conducted using standard 37° C. water bath thawing or using a dry thawing device. Further, this benefit was seen across various solutions, CPAs, CPA combinations, CPA concentrations, and freeze protocols.

### Example 7: Human Prostate Cells

The studies described in example 7 focus on the collection of cell survival data and the impact of post-thaw conditioning on human prostate cells. Specific activities included standard cryopreservation protocol and collection of data (survival and cell death) from samples frozen using 3 unique cryopreservation solutions (Media with 0, 2 and 5% DMSO) and oxidative stress modulation (NAC). Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard controlled rate suspension freeze protocols and analyzed following 24 hours to 3 days post thaw for survival and recovery. These experiments were conducted to evaluate the impact of molecular modulators (inhibitors) during post-thaw recovery on cell survival when added to the dilution media following cryopreservation. Experimentation built upon previous results in examples 5-6, and focused on survival analysis based on cellular plating and re-growth using the metabolic activity assay AlamarBlue. To this end, samples were probed with AlamarBlue, incubated for 60 mins in the dark and then assessed using a Tecan micro plate reader. Assessment was conducted at 24, 48 and 72 hours post-thaw to allow for assessment of solution and post-thaw conditioning agent performance and sample recovery.

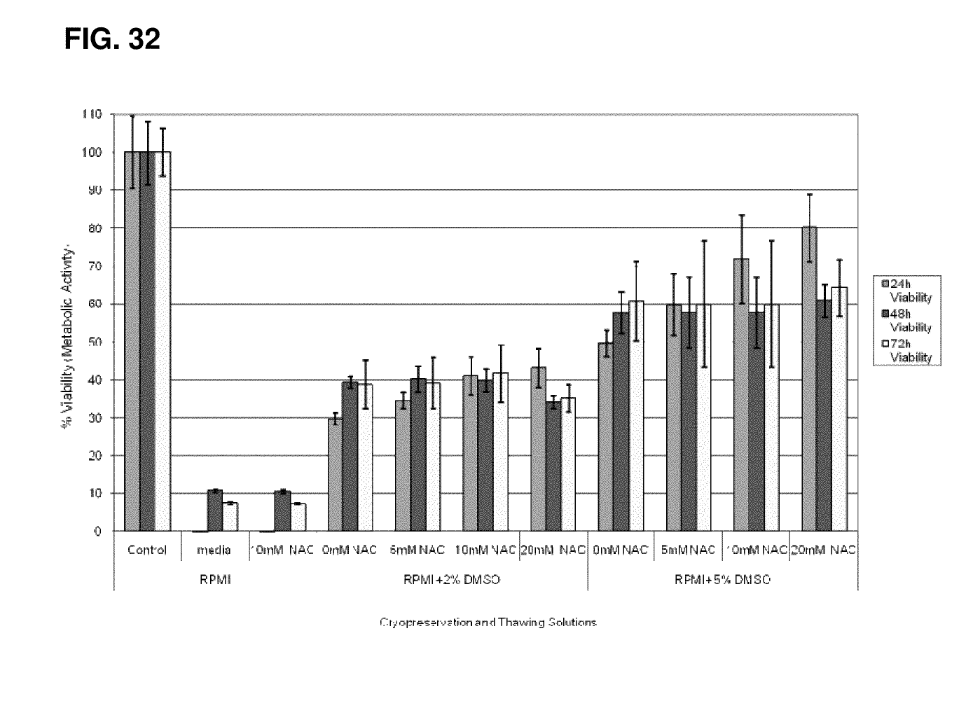

FIG. 32 illustrates the human prostate cell survival following cryopreservation in media-based solutions with various CPA concentrations. Prostate cell suspensions were frozen and thawed in the indicated solutions. Following thawing, samples were placed into culture and assessed for viability at 1 day (24 hours) post-thaw using the AlamarBlue assay. As expected, control (non-frozen) samples revealed a high number of cells indicating a healthy culture. Analysis indicates that the media (RPMI)+CPA solutions provided for improved survival and repopulation based on the concentration of the CPA. This was consistent with findings in all other cell types.

With the establishment of 24 hour human prostate cell survival following cryopreservation, analysis of the impact of oxidative stress (NAC) inhibition during post-thaw recovery (PW) was conducted. As with the viability studies above, cell survival and repopulation were assessed using AlamarBlue.

For prostate cell post-warming (PW) conditioning studies, following thawing the CP solution of each sample was diluted with culture media supplemented with the respective molecular modulator. Samples were incubated in culture for 24 hours then assessed. The data in FIG. 32 illustrate the improvement in post-thaw survival of prostate cells following PW conditioning compared to non-modulated samples. This protective benefit was seen regardless of whether the thawing process was conducted using standard 37° C. water bath thawing or using a dry thawing device. Further, this benefit was seen across various solutions, CPAs, CPA combinations, CPA concentrations, and freeze protocols.

### Example 8: Cryopreservation of Hamster Beta Islet Cells

The studies described in example 8 focus on the collection of cell survival data and the impact of post-thaw conditioning on hamster beta islet cells. Specific activities included standard cryopreservation protocol and collection of data (survival and cell death) from samples frozen using 3 unique cryopreservation solutions (media with 0, 5% DMSO and 5% DMSO+NAC) and oxidative stress PW modulation (NAC). Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard controlled rate suspension freeze protocols and analyzed following 24 hours to 3 days post thaw for survival and recovery. These experiments were conducted to evaluate the impact of molecular modulators (inhibitors) during post-thaw recovery on cell survival when added to the dilution media following cryopreservation. Experimentation built upon previous results in examples 5-7 and focused on survival analysis based on cellular plating and re-growth using the metabolic activity assay AlamarBlue. To this end, samples were probed with AlamarBlue, incubated for 60 mins in the dark and then assessed using a Tecan micro plate reader. Assessment was conducted at 24, 48 and 72 hours post-thaw to allow for assessment of solution and post-thaw conditioning agent performance and sample recovery.

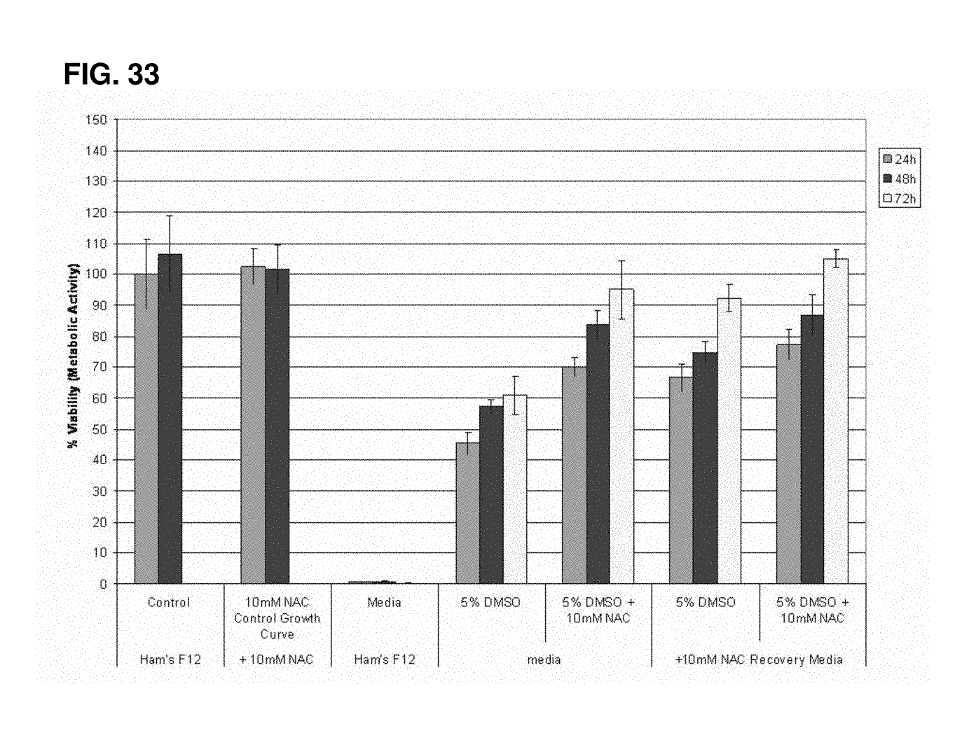

FIG. 33 illustrates the results of an assessment of beta islet cell survival following cryopreservation in media based solutions with various CPA concentrations. Beta islet cell suspensions were frozen and thawed in the indicated solutions. Following thawing, samples were placed into culture and assessed for viability at 1 day (24 hours) post-thaw using the AlamarBlue assay. As expected, control (non-frozen) samples revealed a high number of cells indicating a healthy culture. Analysis indicates that the Media (Hams F12K)+CPA solutions provided for improved survival and repopulation based on the concentration of the CPA. This was consistent with findings in all other cell types.

With the establishment of 24 hour human prostate cell survival following cryopreservation, analysis of the impact of oxidative stress (NAC) inhibition during post-thaw recovery (PW) was conducted. As with the viability studies above, cell survival and repopulation were assessed using AlamarBlue.

For beta islet cell post-warming (PW) conditioning studies, following thawing the CP solution of each sample was diluted with culture media supplemented with the respective molecular modulator. Samples were incubated in culture for 24 hours, then assessed. The data in FIG. 33 illustrate the improvement in post-thaw survival of beta islet cells following PW conditioning compared non-modulated samples. This protective benefit was seen regardless of whether the thawing process was conducted using a standard 37° C. water bath thawing or a dry thawing device. Additionally, the data in FIG. 33 demonstrate that the PW conditioning process is compatible with both traditional CP solutions and strategies as well as CP protocols which implement molecular control during CP (in the CP solution) as well (e.g. FIG. 33; 5% DMSO+NAC+10 mM NAC recovery media condition). Further, this benefit was seen across various solutions, CPAs, CPA combinations, CPA concentrations, and freeze protocols.

### Example 9: Hamster Beta Islet Cells, Hypothermic Storage

The studies described in example 9 focus on the collection of cell survival data and the impact of PW conditioning on hamster beta islet cells following hypothermic (cold, 4° C.) storage preservation. Specific activities included standard hypothermic storage protocol for 3 days and collection of data (survival and cell death) from samples frozen using 1 preservation solution (media, HamsF12K) and two PW modulators; oxidative stress (NAC) and Jun Kinase pathway inhibition (JNK). Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard adherent cell hypothermic storage protocol, stored for 3 days, returned to culture and analyzed following 24 hours and 48 hours for survival and recovery. These experiments were conducted to evaluate the impact of molecular modulators (inhibitors) during post-storage recovery on cell survival when added to the dilution media following hypothermic storage. Experimentation built upon previous results in examples 5-7 and focused on survival analysis based on cellular plating and re-growth using the metabolic activity assay AlamarBlue. To this end, samples were probed with AlamarBlue, incubated for 60 mins in the dark and then assessed using a Tecan micro plate reader. Assessment was conducted at 24 and 48 hours to allow for assessment of solution and conditioning agent performance and sample recovery.

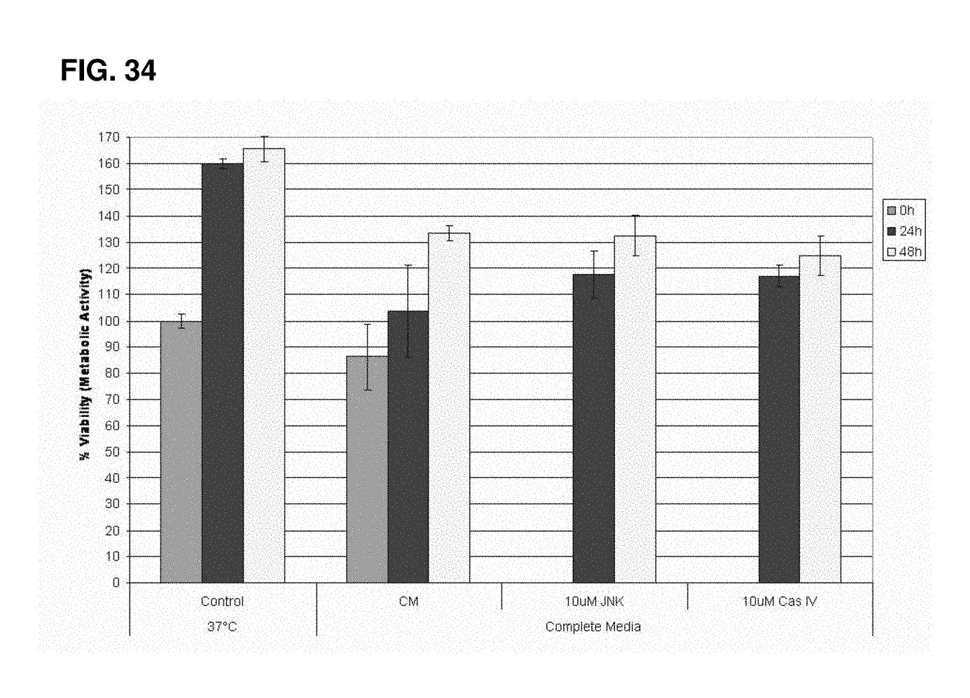

FIG. 34 illustrates beta islet cell survival following hypothermic storage in culture media. Following storage, samples were placed into culture and assessed for viability at 1 day (24 hours) post-thaw using the AlamarBlue assay. As expected, control (non-frozen) samples revealed a high number of cells indicating a healthy culture. Analysis indicates that the media (Hams F12K) solutions provided for a low level of survival and repopulation. This was consistent with findings in all other cell types.

Analysis of the impact of caspase (CIV) and oxidative stress (JNK) inhibition during post-storage recovery (PW) was conducted. As with the viability studies above, cell survival and repopulation were assessed using AlamarBlue.

For beta islet cell post-warming (PW) conditioning studies, following storage, the storage solution was removed and culture media supplemented with the respective molecular modulator was added to each sample. Samples were incubated in culture for 24 hours then assessed. The data in FIG. 34 illustrate the improvement in survival of beta islet cells following PW conditioning compared to non-modulated samples. This protective benefit was seen regardless of whether the warming process was conducted using a standard 37° C. water bath, a dry thawing device, or passive warming. Further, this benefit was seen across various solutions.

### Example 10: Human Periodontal Ligament Fibroblast Cells

The studies described in example 10 focus on the collection of cell survival data and the impact of post-warming conditioning on human periodontal ligament fibroblast cells following hypothermic (cold, 4° C.) storage preservation. Specific activities included standard hypothermic storage protocol for 3 days and collection of data (survival and cell death) from samples frozen using 2 preservation solutions (media (SCGM) and HBSS) and the PW oxidative stress modulator NAC. Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard adherent cell hypothermic storage protocol, stored for 3 days, returned to culture, and analyzed following 24 hours for survival and recovery. These experiments were conducted to evaluate the impact of molecular modulators (inhibitors) during post-storage recovery on cell survival when added to the dilution media following hypothermic storage. Experimentation built upon previous results in example 9, and focused on survival analysis based on cellular plating and re-growth using the metabolic activity assay AlamarBlue. To this end, samples were probed with AlamarBlue, incubated for 60 mins in the dark and then assessed using a Tecan micro plate reader. Assessment was conducted at 24 hours to allow for assessment of solution and conditioning agent performance and sample recovery.

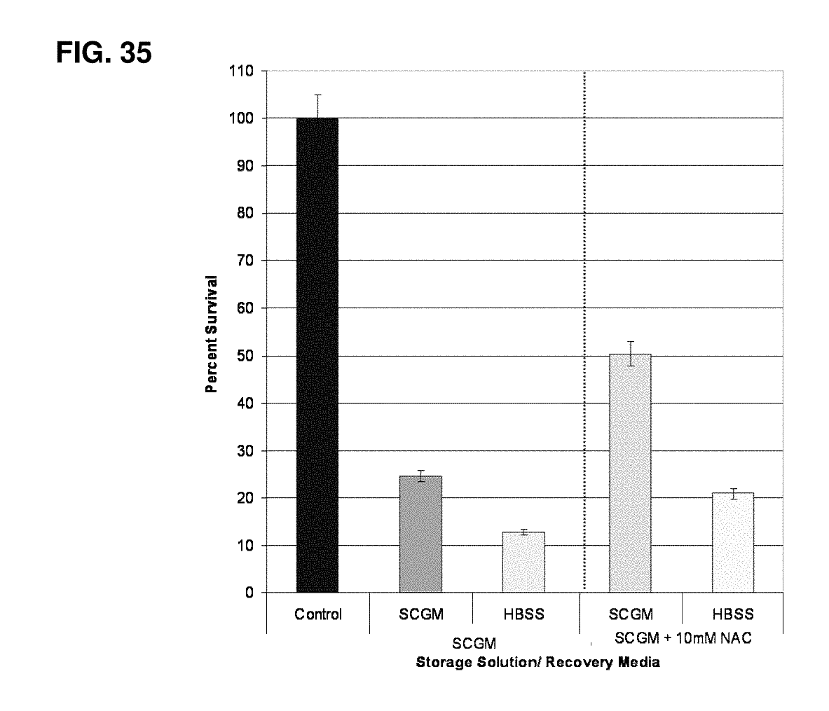

FIG. 35 illustrates fibroblast cell survival following hypothermic storage in culture media. Following storage, samples were placed into culture and assessed for viability at 1 day (24 hours) post-thaw using the AlamarBlue assay. As expected, control (non-frozen) samples revealed a high number of cells indicating a healthy culture. Analysis indicates that the media (SCGM) and HBSS solutions provided for a low level of survival and repopulation. This was consistent with findings in all other cell types.

Analysis of the impact of oxidative stress (NAC) inhibition during post-storage recovery (PW) was conducted. As with the viability studies above, cell survival and repopulation were assessed using AlamarBlue.

For fibroblast cell post-warming (PW) conditioning studies, following storage the storage solution was removed and culture media supplemented with the respective molecular modulator was added to each sample. Samples were incubated in culture for 24 hours then assessed. The data in FIG. 35 illustrate the improvement in survival of fibroblast cells following PW conditioning compared to non-modulated samples. This protective benefit was seen regardless of whether the warming process was conducted using a standard 37° C. water bath, a dry thawing device, or passive warming of samples. Further, this benefit was seen across various solutions.

### Example 11: Human Periodontal Ligament Fibroblast Cells

The studies described in example 11 focus on the collection of cell survival data and the impact of post-thaw conditioning on human periodontal ligament fibroblast cells following hypothermic (cold, 4° C.) storage preservation. Specific activities included standard hypothermic storage protocol for 3 days and collection of data (survival and cell death) from samples frozen using 2 preservation solutions (media (SCGM) and HBSS) and the PW apoptotic modulator CIV. Survival was determined at 24 hours post-thaw to allow for the manifestation of any delayed onset cell death pathways to be executed. Further, cell recovery was included to evaluate the long term potency and repopulation potential of the various samples.

Cell samples were processed according to standard adherent cell hypothermic storage protocol, stored for 3 days, returned to culture and analyzed following 24 hours for survival. These experiments were conducted to evaluate the impact of molecular modulators (inhibitors) during post-storage recovery on cell survival when added to the dilution media following hypothermic storage. Experimentation built upon previous results in example 10 and focused on survival analysis based on cellular plating and re-growth using the metabolic activity assay AlamarBlue. To this end, samples were probed with AlamarBlue, incubated for 60 mins in the dark and then assessed using a Tecan micro plate reader. Assessment was conducted at 24 and 48 hours to allow for assessment of solution and conditioning agent performance and sample recovery.

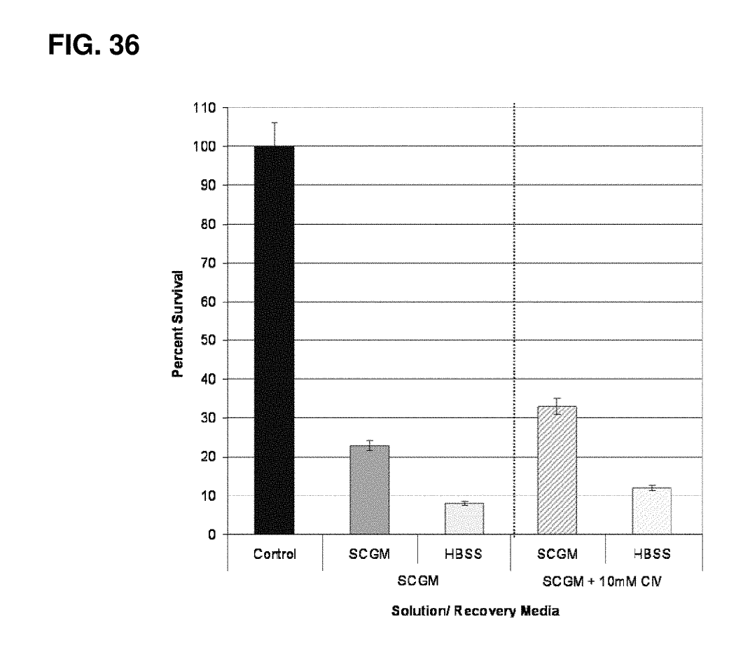

FIG. 36 illustrates the results of an assessment of fibroblast cell survival following hypothermic storage in culture media. Following storage, samples were placed into culture and assessed for viability at 1 day (24 hours) post-thaw using the AlamarBlue assay. As expected, control (non-frozen) samples revealed a high number of cells indicating a healthy culture. Analysis indicates that the media (SCGM) and HBSS solutions provided for a low level of survival and repopulation. This was consistent with findings in all other cell types.

Analysis of the impact of apoptotic inhibition (CIV) inhibition during post-storage recovery (PW) was conducted. As with the viability studies above, cell survival and repopulation were assessed using AlamarBlue.

For fibroblast cell post-warming (PW) conditioning studies, following storage the storage solution was removed and culture media supplemented with the respective molecular modulator was added to each sample. Samples were incubated in culture for 24 hours then assessed. The data in FIG. 36 illustrate the improvement in survival of fibroblast cells following PW conditioning compared to non-modulated samples. This protective benefit was seen regardless of whether the warming process was conducted using a standard 37° C. water bath, a dry thawing device, or passive sample warming. Further, this benefit was seen across various solutions.

### Cryoprotective Agent Studies

As demonstrated in the above examples, e.g., examples 2-3, in addition to investigating PW, PF and P/P conditioning in the above cell types, the studies also examined the impact of various CPAs, concentrations, and combinations as well as preservation solution formulations. As demonstrated in, e.g., FIGS. 1, 2, 15, 28, 30, 31, 32 and 33, the type, concentration, and combination of CPA impacts overall post-thaw cell survival. For instance, stem cells (FIG. 28) have cell loss rates of greater than 50% despite being cryopreserved in optimal DMSO concentrations (10%), and lower DMSO concentrations result in lower survival. Similar results are seen across all cell types including endothelial and smooth muscle cells (FIGS. 2 and 15).

Studies in endothelial and smooth muscle cells revealed that a combination of DMSO and Glycerol as the CPA cocktail resulted in a significant improvement in survival compared with either DMSO or Glycerol alone (FIGS. 2 and 15). Similar outcomes have been observed in other cell systems.

The incorporation of the Unisol-based solutions in Examples 2-3 also allowed for the investigation of the potential for reducing CPA concentration from that of the VS55 and VS83 (55% and 83% CPA respectively), to the 10% to 20% level or lower (i.e., “reduced CPA”). Experiments established that the U10G10 solution (20% CPA total; 10% DMSO and 10% Glycerol) provided for the highest levels of survival (˜50%) followed by U10, U5G10 and U20 at ˜30-40% survival. The benefit of these and other CPA combinations is discussed throughout.

The results with the U10G10 rapid-cooled condition (FIGS. 2 and 15) far exceeded the 1 day post-thaw survival achieved with any condition (suspended or monolayer), reagent, cryopreservation solutions, cooling or warming procedure investigated under this project. Further, it was found that initial day 1 post-thaw cell survival (both endothelial and smooth muscle cell) and cell recovery in all of the Unisol based solutions improved with PF, PW and P/P conditioning with Caspase 8 inhibitor. Improvements in survival were also noted when using the oxidative stress modulator NAC in the PF, PW and P/P condition. Overall the P/P treatment regime with Caspase 8 inhibition yielded the greatest overall increase in improvement (FIGS. 7 and 20). The P/P regime was followed by PW using Caspase 8 inhibition or NAC inhibition. PF treatment yielded minimal improvement in survival following thawing. The greatest increase in survival (>2 fold over non-treated samples) was seen in the U10G10 P/P Caspase 8 condition where day 1 survival was increased to about 70 to 80% that of pre-freeze controls (FIGS. 7 and 20). This initial day 1 survival improvement from the inclusion of the Caspase 8 inhibitor resulted in a marked improvement in cell repopulation over the initial 3 day post-thaw recovery interval compared to all other conditioning agents (FIGS. 8 and 21). PW conditioning with Caspase 8 or NAC resulted in a ˜50% increase in cell survival over that of non-treated samples (FIGS. 5, 13, 18 and 26).

### Discussion of Results

The foregoing examples demonstrate improvements in recovery of a wide variety of cells from cryopreservation and hypothermic storage outcomes under a number of experimental conditions including a variety of CPAs, CPA combinations, CPA concentrations, preservation media, freeze and storage conditions, freeze, thaw, and warming protocols. For example, using either a cell culture media or Unisol-based solution as cryopreservation media in combination with DMSO and/or glycerol positively improved 24 hour survival and repopulation. In particular, U10, U5G10, U20, and U10G10 provided improved survival, with U10G10 providing the most improved sample survival and repopulation.

PW, PF and P/P supplementation with a number of reagents improved cell survival and recovery under a number of experimental conditions. This improvement was found across a variety of preservation media, CPAs, CPA combinations, CPA concentrations, and cell types. In particular, PW conditioning with apoptosis inhibitors (caspase 8 inhibitor, caspase IV inhibitor) or oxidative stress inhibitors (NAC) provided improved sample survival, and P/P conditioning with caspase 8 inhibitor or NAC provided further improved sample survival and repopulation. P/P conditioning with caspase 8 or NAC in particular resulted in a significant improvement in sample survival and cell repopulation. Most notably, P/P using caspase 8 resulted in about 80% human endothelial cell survival and about 70% smooth muscle cell survival following cryopreservation in U10G10. Together these activities established the utility of U10G10 with P/P caspase inhibition for cryopreservation. Most notably, the use of molecular modulation in the post-warming conditioning (PW) of previously preserved samples is useful for improving recovery of samples which may have been previously preserved using suboptimal storage practices. This was most notable with the application of apoptotic and oxidative stress inhibitors including of Caspase 8, 9, IV and NAC during the post-preservation recovery process.

The concentration ranges of the reagents included 1 μM to 500 mM, or more particularly, from 5 μM to 20 mM in the conditioning media. Formulation of the conditioning reagent consisted of 1× to 100×, which was then diluted into a base culture medium, salt solution, or other medium for application to the samples. The various formulas of conditioning reagents were prepared as singular reagents or as a combination of any two or more reagents. The concentration of each of the reagents differed based on the desired working concentration and whether the conditioning reagent is formulated as a 1× or more concentrated (up to 100× or greater) formulation.

### Compositions of the Disclosure

Following from the examples described above, compositions of the disclosure are provided for use in preserving and/or recovering a biological sample.

In one embodiment, the composition may be a conditioning medium, which may be in the form of a liquid solution or suspension, a powder, or a tablet. The conditioning medium is configured to be added to a conditioning medium base, e.g., cell culture media, salt solution, preservation media, etc., to improve sample recovery and survival following preservation. The conditioning medium is compatible with all preservation and culture media types, and achieves improvements in cell recovery (survival, viability and/or function) without major process changes.

The conditioning medium composition includes at least one reagent added to the base solution, the reagent being capable of modulating a molecular pathway in a biological sample. The reagent may modulate, e.g., oxidative stress, free radical scavenging, cell death inhibition (apoptosis, necrosis, necroptosis), Unfolded Protein Response (UPR), or cell survival activation. The individual reagent concentration may range from 1 μM to 500 mM, from 5 μM to 20 mM, or from 10 nM to 1 mM as the reagent concentration in the conditioning media. In other embodiments, the reagent may target any of the following stress response and/or survival process pathways such as, e.g., mitochondrial, membrane, cytoskeleton, endoplasmic rectum, Golgi apparatus, lysosomes, nucleus, genome, proteome, transcriptome, vasculature, immune response/system, etc. The reagent may include one or more of the following types of compounds: proteins, antibodies, nucleotide sequences (DNA, RNA, RNAi, siRNA, SNIPS, etc.), vitamins including but not limited to vitamins D, A, C, E, B and analogs, antioxidants, free radical scavengers (FRSs) including but not limited to glutathione, DMSO, resveratrol, ubiquinol, oxalic acid, tannins, and phytic acid, oxidative stress inhibitors including but not limited to n-acetyl cysteine (NAC), nitrous oxide, N^{G},N^{G}-Dimethyl-L-arginine Dihydrochloride, and N^{G}-Monomethyl-L-arginine, cell death chemical agents including but not limited to caspase, ROCK, calpain, cathepsins, Necrostatin-1, Necrosis Inhibitor IM-54, and DL-Thiotic acid, Unfolded Protein Response agents including but not limited to salubrinal (Sal) and tunicamycin, cell survival activation agents including but not limited to AKT, PI3K, and cyclins, and natural and synthetic reagents that inhibit cell death or promote cell survival. As described, the concentration of the reagent may range from 1 μM to 500 mM. More specifically, from 5 μM to 20 mM as the final working reagent concentration in the conditioning media. Depending on the reagent the concentration range may extend into the 10 nM to 1 mM range. Formulation of the conditioning reagent may be 1× to 100×. In some embodiments, the reagent may be, e.g., a caspase inhibitor such as, e.g., a caspase 8 inhibitor, a caspase 9 inhibitor, or a caspase IV inhibitor. In other embodiments, the reagent may be, e.g., a free radical scavenger, e.g., resveratrol; an unfolded protein response (UPR) modulator, e.g., salubrinal; or an oxidative stress modulator, e.g., n-acetyl cysteine (NAC).

The reagent contained in the supplement may include one or more of the following types of compounds: proteins, antibodies, nucleotide sequences (DNA, RNA, RNAi, siRNA, SNIPS, etc.), vitamins including but not limited to vitamins D, A, C, E, B and analogs, antioxidants, free radical scavengers (FRSs) including but not limited to glutathione, DMSO, resveratrol, ubiquinol, oxalic acid, tannins, and phytic acid, oxidative stress inhibitors including but not limited to n-acetyl cysteine (NAC), nitrous oxide, N^{G},N^{G}-Dimethyl-L-arginine Dihydrochloride, and N^{G}-Monomethyl-L-arginine, cell death chemical agents including but not limited to caspase, ROCK, calpain, cathepsins, Necrostatin-1, Necrosis Inhibitor IM-54, and DL-Thiotic acid, Unfolded Protein Response agents including but not limited to salubrinal (Sal) and tunicamycin, cell survival activation agents including but not limited to AKT, PI3K, and cyclins, and natural and synthetic reagents that inhibit cell death or promote cell survival. In some embodiments, the reagent may be, e.g., a caspase inhibitor such as, e.g., a caspase 8 inhibitor, a caspase 9 inhibitor, or a caspase IV inhibitor. In other embodiments, the reagent may be, e.g., a free radical scavenger, e.g., resveratrol; an unfolded protein response (UPR) modulator, e.g., salubrinal; or an oxidative stress modulator, e.g., n-acetyl cysteine (NAC). In other embodiments, the reagent may be a combination of any of the foregoing reagents or classes of reagents.

As previously described, the conditioning medium may be added to, or may be used to supplement a conditioning medium base. In various exemplary embodiments, the conditioning medium base may be, or be similar to, an extracellular-like solution such as, e.g., cell culture media, Hank's Balanced Salt Solution (HBSS), phosphate-buffered saline (PBS), and others as known in the art. In other embodiments, the conditioning medium base may be, or be similar to, an intracellular-like solution such as, e.g., VIASPAN (University of Wisconsin or UW Solution), HYPOTHERMOSOL (BioLife Solutions, Inc.), CRYOSTOR (BioLife Solutions, Inc.), UNISOL (Lifeline Scientific, Inc.), SYNTHA-A-FREEZE (ThermoFisher), RECOVERY CELLCULTURE FREEZE MEDIUM (ThermoFisher), CUSTODIOL HTK (Essential Pharmaceuticals), Optisol GS (Bausch and Lomb), Eurocollins (Corning), etc., and any similar solutions produced under other brands. In other embodiments, the conditioning medium base liquid may be an alcohol, water, or other simple liquid.

The formulary of the conditioning medium or solution base may contain any combination and/or concentration of compounds/ingredients found in typical salt solution, culture media or preservation media. Formulary ingredient/compound categories can include, but are not limited to: inorganic salts, amino acids, antioxidants, trace elements, bases, nucleosides, energy substrates, lipids or lipid precursors, metabolic support agents, impermeant, buffers, pharmacologic agents, antibiotics, vitamins, and pH indicators. For example, the formulary of the base medium for the conditioning solution described herein may contain ingredients and concentrations similar to that of extracellular-like medias (e.g. HBSS, various culture media (RPMI, Hams F12, SCGM, etc.), EC, among others) and may include one or any combination of: CaCl₂) (0-3 mM); KCl (0-7 mM); KH2PO (0-3 mM); MgCl2 (0-50 mM; MgSO₄ (0-5 mM); NaCl (0-200 mM); NaHCO₃ (0-50 mM); Na₂HPO₄ (0-10 mM); NaHPO₄ (0-15 mM); various amino acids (0-10 mM); various vitamins (0-10 mM); various trace elements (0-1 mM); as well as other various ingredients at concentrations ranges typically found in culture media and salt solutions. Similarly, the formulary of the base medium for the conditioning solution described herein may contain ingredients and concentrations similar to that of intracellular like solutions such as; e.g. Viaspan, Unisol, and others as known in the art and may include one or any combination of: Na+ (20-200 mM); K+(1-150 Mm); Ca++(0-3 mM); Mg++(0-20 mM); Cl− (0-150 mM); SO₄ (0-10 mM); H₂PO₄− (0-30 mM); HPO₄2− (0-10 mM); HCO₃− (0-40 mM); HEPES (0-40 mM); HES (0-10%); dextran (0-10%); various sugars or sugar alcohols (0-50 mM); various impermeants (0-150 mM); various pharmacological agents (0-30 mM); as well as other various ingredients at concentrations ranges found in various intracellular-like solutions which are known in the art.

Upon addition of the conditioning medium to the conditioning medium base, the concentration of the reagent may range from about 1 μM to about 500 mM, from about 5 μM to about 20 mM, or about 1 nM to about 1 mM as the reagent concentration when diluted to form a final conditioning media. The concentration may vary with the reagent selected, as will be appreciated by one of skill in the art. Formulation of the conditioning medium supplement (i.e., conditioning medium+condition medium base) may be, e.g., 1× (final working concentration range) to 100× (highly concentrated reagent stock), or greater, which can be diluted (concentrated liquid) or re-suspended (powder or tablet) into a base culture media, salt solution or other medium for application to the samples. In the case of the concentrated formulation (e.g. 2× to 100× or greater) the concentration of the reagents may be increased up to or greater than the concentrating factor of the formulation.

It is noted that the specific compounds/ingredients and concentration ranges described above are for exemplary purposes and may vary based on the specific formulary of the conditioning medium base as well as the composition of the molecular modulation reagent (described below) and concentrations as biologic (cell, tissue organ, etc.) specific or matched formularies of the conditioning medium base may be desirable.

Regardless of form, compositions of the disclosure may include natural components, synthetic components, or a combination of natural and synthetic components. The compositions of the disclosure may condition or modulate cell stress response, which in turn improve cell survival following cell preservation, e.g., hypothermic storage or cryopreservation. In particular, compositions of the disclosure may modulate cell pathways, and sustain and support cell membrane integrity using, e.g., selective antioxidants or inhibitors of stress-induced cell death. The composition may confer any one or more of the following benefits on the biological sample to be preserved or following preservation: the composition may protect, sustain, or improve quality (for instance; survival, function, repopulation, among others) of the biological sample following preservation.

In another composition, a cryoprotective agent compound formulation consists of a variety of cryoprotective agents alone or in combination. These agents include DMSO, glycerol, ethylene glycol, alcohols, propylene glycol, glucose, sucrose, trehalose, hydroxyethylstarch, dextran sulfate, methylcellulose and polyvinylpyrollidone, sorbitol, galatitol, fuctiol, polyglycitol, ice recrystallization inhibitors alone and in combination with one another. Regardless of the cryoprotective agents, the medium may contain up to about 100% cryoprotective agent by volume within the cryoprotective agent compound formulation. The cryoprotective agent compound formulation can be added to any media class or formulary (extra or intracellular like solutions) being used to preserve a biologic diluted to a final CPA concentration up to 50% or greater. More specifically, final cryoprotective agent concentration of 20% or less is preferable. In various illustrative examples, the solution may be, for example: about 5% DMSO and about 10% glycerol (total about 15% CPA), or about 10% DMSO and about 10% glycerol (total about 20% CPA). The formulary of the cryoprotective agent supplement base solution may contain any combination of compounds/ingredients with concentrations as outline for the conditioning medium base.

The cryoprotective agent supplement base solution may be an alcohol, water or other simple liquid. In other cases, the cryoprotective agent supplement base solution may be similar to an extracellular-like solution such as, e.g., cell culture media, Hank's Balanced Salt Solution (HBSS), phosphate-buffered saline (PBS), and others as known in the art. In yet another case, the cryoprotective agent supplement base solution may be similar to that of intracellular like solution such as; e.g. Viaspan, Unisol, and others as known in the art.

The specific compounds/ingredients and concentrations described above are for exemplary purposes and may vary based on the specific formulary of the cryoprotective agent supplement base solution as well as the composition of the cryoprotective agents and concentrations as biologic (cell, tissue organ, etc.) specific or matched formularies of the cryoprotective agent supplement may be desirable.

### Methods of the Disclosure

According to embodiments of the disclosure, methods are provided herein for conditioning biological materials prior to, following or both prior to and following preservation.

In one embodiment, a method may include pre-conditioning a biological sample prior to preservation, e.g., cryopreservation, vitrification or hypothermic storage, with a reagent selected from: proteins, antibodies, nucleotide sequences (DNA, RNA, RNAi, siRNA, SNIPS, etc.), vitamins including but not limited to vitamins D, A, C, E, B and analogs, antioxidants, free radical scavengers (FRSs) including but not limited to glutathione, DMSO, resveratrol, ubiquinol, oxalic acid, tannins, and phytic acid, oxidative stress inhibitors including but not limited to n-acetyl cysteine (NAC), nitrous oxide, N^{G},N^{G}-Dimethyl-L-arginine Dihydrochloride, and N^{G}-Monomethyl-L-arginine, cell death chemical agents including but not limited to caspase, ROCK, calpain, cathepsins, Necrostatin-1, Necrosis Inhibitor IM-54, and DL-Thiotic acid, Unfolded Protein Response agents including but not limited to salubrinal (Sal) and tunicamycin, cell survival activation agents including but not limited to AKT, PI3K, and cyclins, and natural and synthetic reagents that inhibit cell death or promote cell survival. In some embodiments, the reagent may be, e.g., a caspase inhibitor such as, e.g., a caspase 8 inhibitor, a caspase 9 inhibitor, or a caspase IV inhibitor. In other embodiments, the reagent may be, e.g., a free radical scavenger, e.g., resveratrol; an unfolded protein response (UPR) modulator, e.g., salubrinal; or an oxidative stress modulator, e.g., n-acetyl cysteine (NAC). In still other embodiments, the reagent may be a combination of any of the foregoing reagents or classes of reagents. After undergoing pre-freeze conditioning with a reagent, the sample may be cryopreserved in an extracellular-like preservation medium or an intracellular-like preservation medium with a cryoprotective agent.

In another embodiment, a method may include pre- and post-conditioning a biological sample, i.e., conditioning the sample both before preservation and after rewarming. According to an exemplary method, one hour prior to cryopreservation, culture media may be decanted and fresh media supplemented with a reagent may be added to each sample. Alternatively, the conditioning medium may be added directly to the culture media already on a sample. Samples may then be incubated at 37° C. for 1 hour (shorter or longer incubation periods may be employed), followed by media removal and addition of culture medium according to a single step or serial addition and dilution protocol, and sample cryopreservation or hypothermic storage in an extracellular-like preservation medium or an intracellular-like preservation medium, either with or without a cryoprotective agent. The sample may then be warmed, followed by removing or diluting the preservation medium, and adding reagent-supplemented culture medium (e.g. conditioning medium) to the biological sample. The reagent-supplemented conditioning medium may also be used directly as the dilution media for the cryopreserved sample. The reagent used to pre-condition the sample may be the same as or different from the reagent used to condition the sample post-warming. The pre- and post-conditioning reagents may be independently selected from: proteins, antibodies, nucleotide sequences (DNA, RNA, RNAi, siRNA, SNIPS, etc.), vitamins including but not limited to vitamins D, A, C, E, B and analogs, antioxidants, free radical scavengers (FRSs) including but not limited to glutathione, DMSO, resveratrol, ubiquinol, oxalic acid, tannins, and phytic acid, oxidative stress inhibitors including but not limited to n-acetyl cysteine (NAC), nitrous oxide, N^{G},N^{G}-Dimethyl-L-arginine Dihydrochloride, and N^{G}-Monomethyl-L-arginine, cell death chemical agents including but not limited to caspase, ROCK, calpain, cathepsins, Necrostatin-1, Necrosis Inhibitor IM-54, and DL-Thiotic acid, Unfolded Protein Response agents including but not limited to salubrinol (Sal) and tunicamycin, cell survival activation agents including but not limited to AKT, PI3K, and cyclins, and natural and synthetic reagents that inhibit cell death or promote cell survival. In some embodiments, the reagent may be, e.g., a caspase inhibitor such as, e.g., a caspase 8 inhibitor, a caspase 9 inhibitor, or a caspase IV inhibitor. In other embodiments, the reagent may be, e.g., a free radical scavenger, e.g., resveratrol; an unfolded protein response (UPR) modulator, e.g., salubrinal; or an oxidative stress modulator, e.g., n-acetyl cysteine (NAC). In still other embodiments, the reagent may be a combination of any of the foregoing reagents or classes of reagents.

In yet another embodiment, a method may include post-conditioning a thawed or warmed biological sample. Such a method may include preserving a biological sample in an extracellular-like preservation medium or an intracellular-like preservation medium, thawing or warming the preserved biological sample, removing the preservation medium, and adding supplemented culture medium to the biological sample. The reagent-supplemented conditioning medium may also be used directly as the dilution media for the preserved sample. The supplement included in the culture medium and added to the sample post-thaw may include a reagent used to post-condition the sample such as, e.g.: proteins, antibodies, nucleotide sequences (DNA, RNA, RNAi, siRNA, SNIPS, etc.), vitamins including but not limited to vitamins D, A, C, E, B and analogs, antioxidants, free radical scavengers (FRSs) including but not limited to glutathione, DMSO, resveratrol, ubiquinol, oxalic acid, tannins, and phytic acid, oxidative stress inhibitors including but not limited to n-acetyl cysteine (NAC), nitrous oxide, N^{G},N^{G}-Dimethyl-L-arginine Dihydrochloride, and N^{G}-Monomethyl-L-arginine, cell death chemical agents including but not limited to caspase, ROCK, calpain, cathepsins, Necrostatin-1, Necrosis Inhibitor IM-54, and DL-Thiotic acid, Unfolded Protein Response agents including but not limited to salubrinal (Sal) and tunicamycin, cell survival activation agents including but not limited to AKT, PI3K, and cyclins, and natural and synthetic reagents that inhibit cell death or promote cell survival. In some embodiments, the reagent may be, e.g., a caspase inhibitor such as, e.g., a caspase 8 inhibitor, a caspase 9 inhibitor, or a caspase IV inhibitor. In other embodiments, the reagent may be, e.g., a free radical scavenger, e.g., resveratrol; an unfolded protein response (UPR) modulator, e.g., salubrinal; or an oxidative stress modulator, e.g., n-acetyl cysteine (NAC). In still other embodiments, the reagent may be a combination of any of the foregoing reagents or classes of reagents. This method may be performed on any previously frozen (already banked) biological sample regardless of whether any pre-conditioning was performed, and regardless of a number of variables in sample type, cryopreservation medium, cooling protocol, warming protocol, etc. In a particular embodiment, the post-conditioning reagent may be a Caspase inhibitor or NAC.

In all of the foregoing methods of the disclosure, the preservation medium used may be an extracellular-like solution such as, e.g., cell culture media, Hank's Balanced Salt Solution (HBSS), phosphate-buffered saline (PBS), and others as known in the art, or may be an intracellular-like solution such as e.g., VIASPAN (University of Wisconsin or UW Solution), HYPOTHERMOSOL (BioLife Solutions, Inc.), CRYOSTOR (BioLife Solutions, Inc.), UNISOL (Lifeline Scientific, Inc.), SYNTHA-A-FREEZE (ThermoFisher), RECOVERY CELLCULTURE FREEZE MEDIUM (ThermoFisher), CUSTODIOL HTK (Essential Pharmaceuticals), OPTISOL GS (Bausch and Lomb), Eurocollins (Corning), etc., and any similar solutions produced under other brands. Any now known or later developed substantially equivalent solutions produced by other manufacturers and/or marketed under other names are equally considered part of the disclosure.

In yet another method, preservation media itself may then be supplemented with a cryoprotective agent compound formulation. The cryoprotective agent compound formulation may contain a variety of cryoprotective agents alone or in combination including, DMSO, glycerol, ethylene glycol, propylene glycol, alcohol, glucose, sucrose, trehalose, hydroxyethylstarch, dextran sulfate, methylcellulose and polyvinylpyrollidone, sorbitol, galatitol, fuctiol, polyglycitol, ice recrystallization inhibitors alone and in combination with one another. Regardless of the cryopreservation medium and cryoprotective agent compound formulation, the final medium may contain up to about 50% or greater cryoprotective agent by volume for preserving biological samples. More specifically, final cryoprotective agent concentration may by up to 20% or less. Once the cryoprotective agent compound formulation has been added to the preservation media to the final desired working concentration (typically less than 20%) the solution is added to the biological sample, incubated and then the sample preserved using any method known in the art. The cryoprotective agent supplement may also be added directly to samples already placed within a preservation media. In various illustrative examples, the final working CPA solution may be, for example: about 5% DMSO and about 10% glycerol (total about 15% CPA), or about 10% DMSO and about 10% glycerol (total about 20% CPA).

The molecular conditioning reagents and methods described above and illustrated in the examples provided herein (e.g., pre-storage, post-storage and pre/post-storage conditioning) have been shown to be universally useful for improving sample quality. These methods are compatible with all types of biological samples, preservation strategies, preservation media, storage temperatures, storage times, sample cooling/preserving strategies, and thawing strategies, among other variables typical of the cryopreservation process. In various embodiments, the biological materials to be stored may be, e.g., cells, tissues, organs, proteins, serum, plasma, DNA, RNA, biopsies, and other types of biological samples. The biological material may also include samples which are normal, cancerous, genetically modified, etc. Further, the samples may derive from various sources and species, including animal (including human), plant, bacteria, virus, fungi, etc. The post-warming conditioning methods described herein may be particularly useful for recovery of rare cell and tissue systems, autologous stem cell products, and banked cord blood. The methods described herein may also be useful for short term hypothermic storage and shipment of tissues and organs, including extended hypothermic preservation intervals, improved sample quality, and on-demand storage of tissues in remote areas/situations.

### Embodiments

In addition to other illustrative embodiments, the disclosure can be seen to comprise one or more of the following illustrative embodiments:

1. A conditioning medium comprising: a growth medium or culture medium, and a first reagent that is a cell molecular pathway modulator.

2. A supplement for addition to a medium, for use in preparing the conditioning medium according to embodiment 1, the supplement comprising a first reagent capable of modulating a molecular pathway in a cell.

3. The conditioning medium of embodiment 1 or the supplement of embodiment 2, wherein the first reagent is selected from the group consisting of: a caspase 8 inhibitor, a caspase 9 inhibitor, a caspase IV inhibitor, resveratrol, salubrinal, and n-acetyl cysteine (NAC).

4. The conditioning medium of embodiment 1 or the supplement of embodiment 2, wherein the first reagent is an apoptotic inhibitor, an oxidative stress modulator, a free radical scavenger, or an Unfolded Protein Response modulator.

5. The conditioning medium of embodiment 1 or the supplement of embodiment 2, wherein the first reagent is an oxidative stress inhibitor, a free radical scavenger, a cell death inhibitor, an Unfolded Protein Response (UPR) modulator, or a cell survival activation modulator or combination thereof.

6. The conditioning medium of embodiment 1 or the supplement of embodiment 2, wherein the reagent is selected from the group consisting of: a protein, an antibody, a nucleotide sequence, a vitamin selected from vitamin D, A, C, E, B and analogs thereof, an antioxidant, glutathione, DMSO, resveratrol, ubiquinol, oxalic acid, tannins, phytic acid, n-acetyl cysteine (NAC), nitrous oxide, NG,NG-Dimethyl-L-arginine Dihydrochloride, and NG-Monomethyl-L-arginine, caspase, ROCK, calpain, cathepsins, Necrostatin-1, Necrosis Inhibitor IM-54, DL-Thiotic acid, salubrinal (Sal), tunicamycin, AKT, PI3K, and cyclins or combination thereof.

7. The conditioning medium of embodiment 1 or the supplement of embodiment 2, further comprising a second reagent differing from the first reagent, wherein the second reagent is selected from the group consisting of: a caspase 8 inhibitor, a caspase 9 inhibitor, a caspase IV inhibitor, resveratrol, salubrinal, and n-acetyl cysteine (NAC).

8. The conditioning medium of any of embodiments 1 and 3-6 or the supplement of any of embodiments 2-6, wherein the medium is an extracellular-like solution or an intracellular-like solution.

9. The supplement of any of embodiments 2-6, wherein the supplement is in the form of a powder, a liquid, or a tablet.

10. The supplement of embodiment 9, wherein the first reagent is present in the supplement in a concentration ranging from 1× to 100× or greater relative to a desired final working concentration of the first reagent in the conditioning medium.

11. The supplement of embodiment 10, wherein the desired final working concentration is from about 1 nM to about 1000 nM, or about 1 μM to about 1000 μM, or about 1 nM to about 500 mM.

12. The conditioning medium of any of embodiments 1 or 3-6, wherein the reagent is present in a concentration of about 1 nM to about 500 nM.

13. The conditioning medium of any of embodiments 1 or 3-6, wherein the reagent is present in a concentration of about 100 nM to about 20 mM.

14. The conditioning medium of any of embodiments 1 or 3-6, wherein the reagent is present in a concentration of about 1 nM to about 5 M.

15. A method comprising: in a medium, warming a biological sample that was previously cryopreserved or stored under hypothermic conditions; and after warming the biological sample in the medium, adding an effective amount of a post-thawing conditioning composition to the medium containing the biological sample to create a conditioned medium, wherein the conditioning composition comprises a first reagent that is a cell molecular pathway modulator, and wherein a concentration of the first reagent in the conditioned medium is 1% to 100% of a concentration of the reagent in the conditioning composition.

16. A method comprising: adding a pre-conditioning reagent to a first medium in which the biological sample is contained, wherein the pre-conditioning reagent is in the form of the conditioning medium of any of embodiments 1 and 3-6 or the supplement of any of embodiments 2-6, incubating the biological sample in the pre-conditioning reagent and the medium for about 1 hour; removing the medium containing the pre-conditioning reagent; adding a second medium to the biological sample; cryopreserving the biological sample or placing the biological sample in hypothermic storage in the second medium; warming a biological sample in the second medium; and after warming the biological sample in the medium, adding an effective amount of a post-warming conditioning reagent to the biological sample, wherein the post-warming-conditioning reagent is in the form of the conditioning medium of any of embodiments 1 and 3-6 or the supplement of any of embodiments 2-6.

17. A method comprising: adding a pre-conditioning reagent to a first medium in which the biological sample is contained, wherein the pre-conditioning reagent is in the form of the conditioning medium of any of embodiments 1 and 3-6 or the supplement of any of embodiments 2-6, incubating the biological sample in the pre-conditioning reagent and the medium for about 1 hour; removing the medium containing the pre-conditioning reagent; adding a second medium to the biological sample; and cryopreserving the biological sample or placing the biological sample in hypothermic storage in the second medium.

18. The method of any of embodiments 15-17, wherein the biological sample comprises a cell, a tissue, or an organ.

19. The method of any of embodiments 15-17, wherein the first medium is a culture medium, and the second medium is a cryopreservation medium.

20. A method of conditioning a biological sample comprising: adding an effective amount of the conditioning medium of embodiment 1 or the supplement of embodiment 2 to a medium containing the biological sample, such that a concentration of a reagent in the composition is 1% to 100% of a concentration of the reagent in the composition, wherein the reagent is present in the composition in a concentration of about 1 nM to about 500 nM, or about 100 nM to about 20 mM, or about 1 nM to about 5 M, the composition is in the form of a tablet, a liquid, or a powder, and the reagent is an apoptotic inhibitor, an oxidative stress modulator, a free radical scavenger, or an Unfolded Protein Response modulator.

21. The method of embodiment 20, wherein the reagent is applied to the biological sample before preservation, after preservation, or both before and after preservation.

22. A cryoprotective agent supplement for use in for the cryopreservation of cells, the supplement comprising: a first reagent capable of protecting biologics from ice damage during the freezing and thawing process.

23. The cryoprotective agent supplement of embodiment 22, in the form of a liquid.

24. The cryoprotective agent supplement of embodiment 23, wherein the liquid is a concentrated formulation ranging from 1× to 100× concentration or greater of a desired final working concentration of the reagent(s) contained therein.

25. The cryoprotective agent supplement of any one of embodiments 20-24, wherein the desired final working cryoprotective agent concentration may by up to 20% or less.

26. The cryoprotective agent supplement of any one of embodiments 22-25, wherein the reagent is selected from the group consisting of: DMSO, glycerol, ethylene glycol, propylene glycol, alcohols, glucose, sucrose, trehalose, hydroxyethylstarch, dextran sulfate, methylcellulose and polyvinylpyrollidone, sorbitol, galatitol, fuctiol, polyglycitol, ice recrystallization inhibitors alone and in combination.

27. A cryopreservation medium comprising: the cryoprotective agent supplement of any one of embodiments 22-27, wherein the cryopreservation medium contains up to about 50% cryoprotective agent supplement by volume.

28. A method preserving a biological sample comprising: pre-conditioning the biological sample with a reagent; and cryopreserving the biological sample.

29. A method of recovering a cryopreserved biological sample comprising: thawing a cryopreserved biological sample; and after thawing the biological sample, conditioning the biological sample with a reagent.

30. A method of recovering a cryopreserved biological sample comprising: thawing a cryopreserved biological sample; and after thawing the biological sample, diluting the sample directly with the conditioning media or media supplemented with the conditioning supplement reagent

31. A method comprising: pre-conditioning the biological sample with a first reagent; cryopreserving the biological sample; thawing the cryopreserved biological sample; and after thawing, conditioning the biological sample with a second reagent.

32. The method of embodiment 31, wherein the first reagent and the second reagent are the same.

33. The method of embodiment 31, wherein the first reagent and the second reagent are not the same.

34. Any preceding method, in which the cryopreserving step is carried out a cryopreservation medium containing about 20% or less cryoprotective agent supplement by volume.

35. A method comprising: adding a cryoprotective agent supplement to a preservation media; cryopreserving the biological sample; and thawing the cryopreserved biological sample.

36. The method of embodiment 35, wherein the cryoprotective agent supplement is added to a preservation media to a final concentration of 50% or less, or 20% or less.

37. The method of embodiment 35, wherein the cryoprotective agent supplement consists of a combination of DMSO and glycerol.

38. The method of embodiment 35, wherein the cryoprotective agent supplement is diluted to a final concentration of about 10% DMSO and 10% glycerol in the preservation media.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A conditioning medium composition comprising:
a medium selected from the group consisting of: a growth medium, a culture medium, a salt solution, an extracellular-like solution, an intracellular-like solution, or a preservation medium; and
a first reagent that is a cell molecular pathway modulator.

2. The conditioning medium composition of claim 1, in the form of a tablet, a powder, or a liquid.

3. The conditioning medium composition of claim 1, wherein the first reagent is selected from the group consisting of: a caspase 8 inhibitor, a caspase 9 inhibitor, a caspase IV inhibitor, resveratrol, salubrinal, and n-acetyl cysteine (NAC).

4. The conditioning medium composition of claim 1, wherein the reagent is present in the composition in a concentration of about 1 nM to about 500 nM.

5. The conditioning medium composition of claim 1, wherein the reagent is present in the composition in a concentration of about 100 nM to about 20 mM.

6. The conditioning medium composition of claim 1, wherein the reagent is present in the composition in a concentration of about 1 nM to about 5 M.

7. The conditioning medium composition of claim 1, further comprising a second reagent differing from the first reagent, wherein the second reagent is selected from the group consisting of: a caspase 8 inhibitor, a caspase 9 inhibitor, a caspase IV inhibitor, resveratrol, salubrinal, and n-acetyl cysteine (NAC).

8. A method comprising:
warming a cryopreserved or hypothermic-stored biological sample in a medium; and
after warming the biological sample, adding an effective amount of a conditioning composition to the medium containing the biological sample to create a conditioned medium,
wherein the conditioning composition comprises a first reagent that is a cell molecular pathway modulator, and
wherein a concentration of the first reagent in the conditioned medium is 1% to 100% of a concentration of the reagent in the conditioning composition.

9. The method of claim 8, wherein the first reagent is selected from the group consisting of: a caspase 8 inhibitor, a caspase 9 inhibitor, a caspase IV inhibitor, resveratrol, salubrinal, and n-acetyl cysteine (NAC).

10. The method of claim 8, wherein the conditioning composition comprises a second reagent differing from the first reagent, wherein the second reagent is selected from the group consisting of: a caspase 8 inhibitor, a caspase 9 inhibitor, a caspase IV inhibitor, resveratrol, salubrinal, and n-acetyl cysteine (NAC).

11. The method of claim 8, wherein the medium is an extracellular-like solution or an intracellular-like solution.

12. The method of claim 8, wherein the adding step is performed within less than 24 hours following the warming step.

13. The method of claim 9, further comprising, prior to the warming step:
adding a pre-conditioning reagent to a first medium in which the biological sample is contained,
wherein the pre-conditioning reagent is selected from the group consisting of: a caspase 8 inhibitor, a caspase 9 inhibitor, a caspase IV inhibitor, resveratrol, salubrinal, and n-acetyl cysteine (NAC):
incubating the biological sample in the pre-conditioning agent and the medium for about 1 hour;
removing the medium containing the pre-conditioning reagent;
adding a second medium to the biological sample; and
cryopreserving the biological sample or placing the biological sample in hypothermic storage in the second medium.

14. The method of claim 8, wherein the biological sample comprises a cell, a tissue, or an organ.

15. The method of claim 13, wherein the first medium is selected from the group consisting of: a growth medium, a culture medium, a salt solution, an extracellular-like solution, an intracellular-like solution; and the second medium is a cryopreservation medium.

16. A conditioning supplement composition comprising a first reagent capable of modulating a molecular pathway in a cell, for use in preparing the conditioning medium according to claim 1.

17. The conditioning supplement composition of claim 16, wherein the first reagent is selected from the group consisting of: a caspase 8 inhibitor, a caspase 9 inhibitor, a caspase IV inhibitor, resveratrol, salubrinal, and n-acetyl cysteine (NAC).
